(19) United States
(12) Patent Application Publication
(10) Pub. No.: US 2026/0014794 A1
(43) Pub. Date: Jan. 15, 2026

(54) LIQUID DISCHARGE APPARATUS AND CONTROL METHOD

(71) Applicant: CANON KABUSHIKI KAISHA, Tokyo (JP)

(72) Inventors: TAKUYA FUKASAWA, Kanagawa (JP); TOSHIAKI TOKISAWA, Tokyo (JP); TETSUYO OHASHI, Kanagawa (JP)

(21) Appl. No.: 19/259,015

(22) Filed: Jul. 3, 2025

(30) Foreign Application Priority Data
Jul. 12, 2024 (JP) 2024-112647
Jul. 19, 2024 (JP) 2024-116039
Apr. 4, 2025 (JP) 2025-062552

(51) Int. Cl. B41J 2/17; B41J 2/045; B41J 2/165

(52) U.S. Cl. CPC B41J 2/1707; B41J 2/04508; B41J 2/04566; B41J 2/16511; B41J 2/16535; B41J 2/04586; B41J 2002/16573; B41J 2002/16594

(57) ABSTRACT

A liquid discharge apparatus including a cap unit configured to cover and cap an orifice surface on which an orifice of a discharge unit configured to discharge a liquid is provided; and a circulation unit configured to communicate with the orifice of the discharge unit, and circulate a liquid through a circulation path, wherein the cap unit includes a first cap configured not to receive the liquid, wherein the circulation unit performs an operation of circulating the liquid through the circulation path in a state in which the cap unit covers the orifice surface.

### CROSS-REFERENCE TO PRIORITY APPLICATIONS

This application claims the benefit of Japanese Patent Application No. 2024-112647, filed Jul. 12, 2024, Japanese Patent Application No. 2024-116039, filed Jul. 19, 2024, and Japanese Patent Application No. 2025-062552 filed Apr. 4, 2025, each of which is hereby incorporated by reference herein in its entirety.

### BACKGROUND

### Field of the Technology

The present disclosure relates to a liquid discharge apparatus and a control method.

### Description of the Related Art

An inkjet printing apparatus is known as an apparatus that discharges a liquid. The inkjet printing apparatus sometimes suffers thickening, fixation, or the like of ink owing to ink drying at a discharge nozzle that discharges ink. Japanese Patent Laid-Open No. 2002-264348 discloses a method of preventing drying and thickening of ink at the distal end of a nozzle by stirring and oscillating ink in a state in which a nozzle opening is capped with a cap holding an ink absorption sheet.

### SUMMARY

The present disclosure provides a technique of suppressing drying of a liquid at a liquid discharge portion when the liquid discharge portion is capped.

The present disclosure in one aspect provides a liquid discharge apparatus comprising a cap unit configured to cover and cap an orifice surface on which an orifice of a discharge unit configured to discharge a liquid is provided; and a circulation unit configured to communicate with the orifice of the discharge unit, and circulate a liquid through a circulation path, wherein the cap unit includes a first cap configured not to receive the liquid, wherein the circulation unit performs an operation of circulating the liquid through the circulation path in a state in which the cap unit covers the orifice surface.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view showing the arrangement of part of a printing apparatus;

FIG. 2 is a schematic view of the printhead of the printing apparatus;

FIG. 3 is a sectional view of the printhead of the printing apparatus;

FIG. 4 is a block diagram for explaining the control system of the printing apparatus;

FIG. 5 is a flowchart showing capping processing;

FIG. 6 is a flowchart showing moisturizing processing;

FIG. 7 is a schematic view showing the arrangement of another let-stand cap mechanism;

FIG. 8 is a flowchart showing capping processing;

FIG. 9 is a flowchart showing moisturizing processing;

FIG. 10 is a view showing the arrangement of part of the printing apparatus;

FIGS. 11A and 11B are views showing another example of a dry cap;

FIG. 12 is a perspective view showing the outer appearance of a liquid discharge apparatus;

FIG. 13 is a block diagram showing the arrangement of a printing control system in the printing apparatus;

FIG. 14 is a view showing an example of a printhead and an orifice group arrangement;

FIG. 15 is a plan view showing a chip;

FIG. 16 is a perspective view showing a recovery unit;

FIG. 17 is a view showing the printhead and wipers;

FIG. 18 is a schematic view showing the arrangement of the printhead and a buffer tank;

FIG. 19 is a sectional view showing orifices, common channels, and recovery channels;

FIG. 20 is a plan view showing the orifices, inlet ports, and outlet ports;

FIG. 21 is a perspective view showing a let-stand unit;

FIG. 22 is a view showing the positional relationship between a recovery unit and the let-stand unit;

FIG. 23 is a graph showing the transition of a relative humidity in a let-stand cap;

FIGS. 24A, 24B, and 24C are flowcharts showing humidification control in the let-stand cap;

FIG. 25 is a graph showing the transition of a relative humidity in the let-stand cap;

FIGS. 26A and 26B are flowcharts showing humidification control and recovery circulation time selection processing;

FIG. 27 is a table showing a recovery circulation time selection table;

FIG. 28 is a flowchart showing humidification control in the let-stand cap;

FIGS. 29A and 29B are a view showing an example of detection of an ink attachment ratio, and a table for selecting the upper limit number of times, respectively;

FIG. 30 is a graph showing the transition of the water evaporation ratio of attached dried ink;

FIG. 31 is a flowchart showing humidification control in the let-stand cap;

FIGS. 32A and 32B are tables that are looked up in the flowchart of FIG. 31; and

FIG. 33 is a flowchart showing humidification control in the cap.

### DESCRIPTION OF THE EMBODIMENTS

Hereafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In a conventional technique, when a cap is opened at the time of a printing operation, ink absorbed in an ink absorption sheet within the cap may evaporate, and a water absorbing component may remain in the ink absorption sheet. If the discharge head is capped again with the cap, the component remaining in the ink absorption sheet can absorb water in ink at the discharge nozzle, drying the ink at the discharge nozzle. To prevent this, some ingenuity is required to suppress drying of a liquid at the liquid discharge portion when the liquid discharge portion is capped.

According to one aspect of the present disclosure, drying of a liquid at the liquid discharge portion can be suppressed when the liquid discharge portion is capped.

### First Embodiment

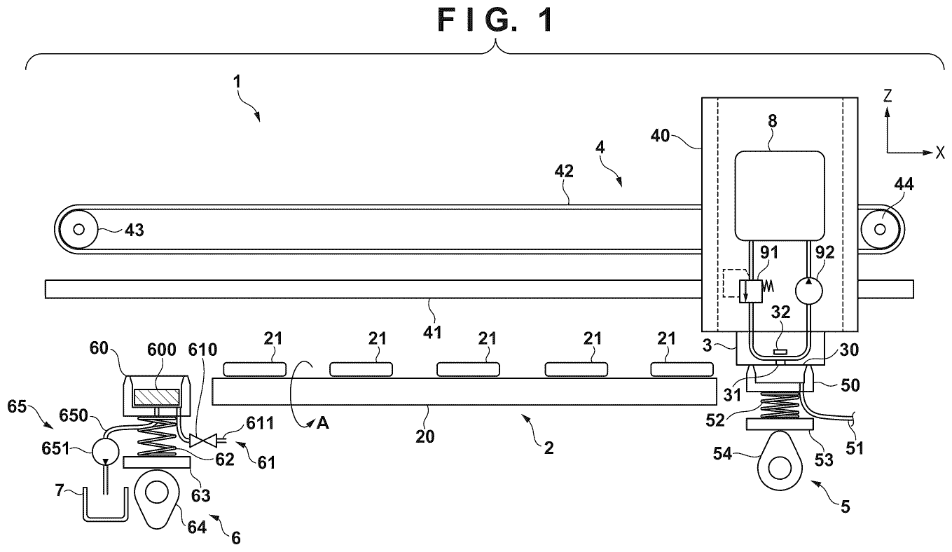

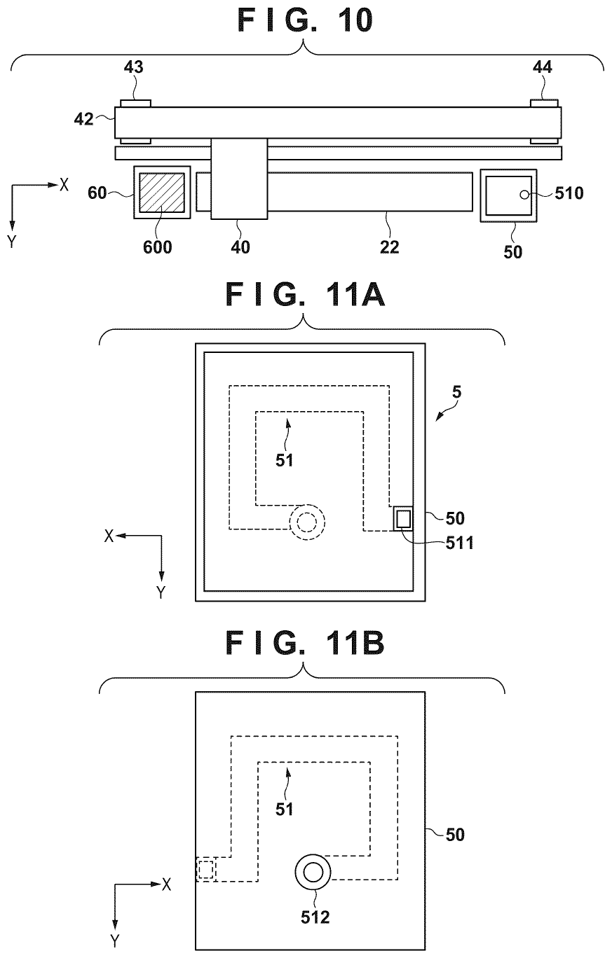

FIGS. 1 and 10 will be referred to. FIG. 1 is an enlarged view of part of a liquid discharge apparatus 1 according to the first embodiment of the present disclosure. FIG. 10 is equivalent to a plan view of part of the liquid discharge apparatus 1. Note that in each drawing, arrows X, Y, and Z indicate directions crossing each other and in this embodiment, orthogonal to each other. A left-and-right direction, a back-and-forth direction, and a top-and-bottom direction when the liquid discharge apparatus 1 is placed on a horizontal surface will be defined as an X direction, a Y direction, and a Z direction, respectively. The X and Y directions can also be called lateral directions.

The liquid discharge apparatus 1 according to the embodiment will be described. The liquid discharge apparatus 1 will be explained using an inkjet printing apparatus (to be referred to as a printing apparatus hereinafter) that prints by discharging ink to a printing medium.

Note that “print” not only includes formation of significant information such as characters and graphics, but also broadly includes formation of images, figures, patterns, and the like on a printing medium or processing of a medium, regardless of whether they are significant or insignificant and whether they are so visualized as to be visually perceivable by humans. The “printing medium” is assumed to be a paper sheet in the embodiment, but may be cloth, a plastic film, or the like.

As shown in FIG. 1, the printing apparatus 1 includes a conveyance unit 2 that conveys a printing medium. The conveyance unit 2 includes a conveyance roller 20 that conveys a printing medium, and a plurality of pinch rollers 21 following the conveyance roller 20. The printing apparatus 1 also includes a platen 22 that supports a printing medium conveyed by the conveyance roller 20 (see FIG. 10).

The printing apparatus 1 further includes a printhead 3 that prints an image by discharging ink serving as a printing material to a printing medium conveyed by the conveyance unit 2. The printhead 3 is arranged to face the platen 22 (see FIG. 10). An image is printed on a printing medium by discharging ink from the printhead 3 to a printing medium conveyed on the platen 22. In other words, the printhead 3 is a discharge head that discharges a liquid. The printhead 3 includes a discharge surface 30 facing a printing medium, and an orifice 31 provided in the discharge surface 30. In other words, the orifice 31 is a discharge nozzle.

The printhead 3 includes a discharge energy generation element 32 such as an electrothermal transducer (heater) or a piezoelectric element, and discharges ink from the orifice 31. For example, when an electrothermal transducer is used as the discharge energy generation element 32, ink can be bubbled by heat generated by the electrothermal transducer, and can be discharged from the orifice 31 using the bubbling energy. The printing method of the printhead 3 is a serial scan method. In the serial scan method, the printhead 3 is mounted on a carriage 40 (to be described later) and reciprocates in the X direction. Discharging ink while moving the printhead 3 in the X direction is called print scanning. The conveyance operation of a printing medium and print scanning of the printhead 3 are alternately repeated, printing an image on the printing medium.

The printing apparatus 1 includes a moving unit 4 that reciprocates the printhead 3 in the X direction. The moving unit 4 includes the carriage 40 on which the printhead 3 is detachably mounted, a guide shaft 41 that supports the carriage 40 movably in the X direction, and a timing belt 42 provided in the X direction. The carriage 40 is connected to the timing belt 42. The moving unit 4 also includes a motor pulley 43 that rotates the timing belt 42, and an idler pulley 44 that faces the motor pulley 43 and supports the timing belt 42 while applying a tension to it. The timing belt 42 is rotated by driving of a carriage (CR) motor 113 (to be described later), and the moving unit 4 reciprocates in the X direction the carriage 40 on which the printhead 3 is mounted.

The printing apparatus 1 includes a dry cap mechanism 5 that caps the printhead 3. Covering the discharge surface 30 of the printhead 3 will be sometimes called capping. The dry cap mechanism 5 includes a dry cap 50, a communication path 51, a press portion 52, a transmission portion 53, and an elevating member 54.

The dry cap 50 is a let-stand cap that covers the discharge surface 30 of the printhead 3 when the printing apparatus 1 is let stand. In other words, the dry cap 50 is a cap that covers the discharge surface 30 of the printhead 3 when the printing apparatus 1 executes neither the printing operation nor the maintenance operation. That is, the dry cap 50 is a cap to which no ink is discharged from the printhead 3.

The dry cap 50 is made of, for example, rubber. Unlike a suction cap 60 (to be described later), the dry cap 50 is a cap having no absorber 600 that absorbs ink. That is, the dry cap 50 is a cap that is not accompanied by suction of ink from the discharge surface 30 when the discharge surface 30 is covered, in other words, a cap that is not connected to a suction unit.

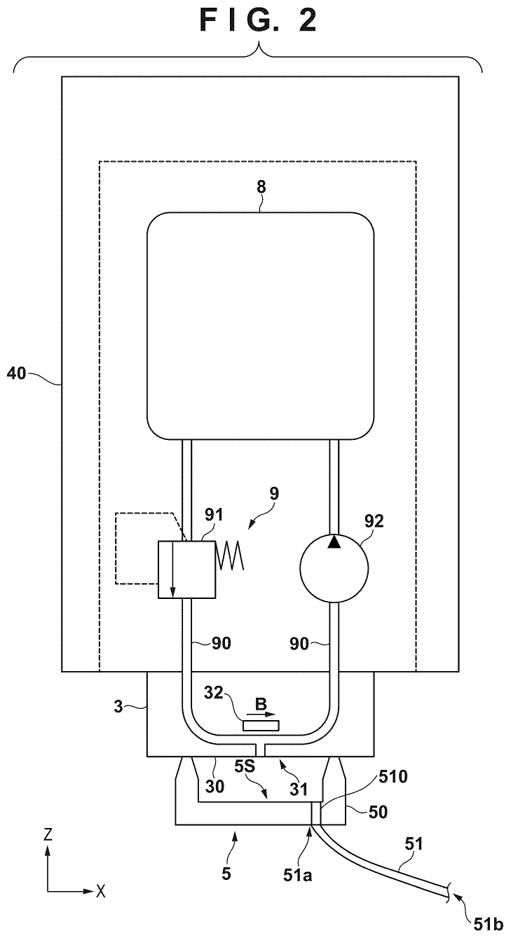

The communication path 51 is connected to the dry cap 50, and makes a dry cap space 5S formed by covering the discharge surface 30 by the dry cap 50 communicate with an external space. The communication path 51 may be, for example, a tube. A through hole 510 is formed in the dry cap 50 and passes through an interval between the dry cap space 5S and the external space. The through hole 510 is also included in part of the communication path 51 (see FIG. 2).

The press portion 52 is, for example, an elastic member such as a spring, and presses the dry cap 50 when the dry cap 50 covers the discharge surface 30. The transmission portion 53 is a plate that transmits the driving force of the elevating member 54 to the press portion 52.

The elevating member 54 is, for example, a cam and rotates in the Y direction to move up/down the dry cap 50 in the direction of height (Z direction) of the printing apparatus 1. Note that the elevating member 54 may move up/down the dry cap 50 using, for example, a cam that operates in synchronization with a rotating operation in the X direction. The elevating member 54 is not limited to the cam and may be a linear actuator, a solenoid, a cylinder, or the like.

The printing apparatus 1 includes a suction cap mechanism 6 used for a maintenance operation (to be described later). The suction cap mechanism 6 includes, for example, the suction cap 60, a communication unit 61, a press portion 62, a transmission portion 63, an elevating member 64, and a suction unit 65.

The suction cap 60 is a cap used at the time of the maintenance operation of the printhead 3. The suction cap 60 is made of, for example, rubber. The suction cap 60 incorporates the absorber 600 that absorbs ink discharged from the printhead 3.

The communication unit 61 includes a communication path 611 that makes a suction cap space formed by covering the discharge surface 30 with the suction cap 60 communicate with an external space. The communication path 611 may be, for example, a tube. The communication unit 61 includes an on-off valve 610 that is provided on the communication path 611 and opens/closes the communication path 611.

The press portion 62 is, for example, an elastic member such as a spring, and presses the suction cap 60 when the suction cap 60 covers the discharge surface 30. The transmission portion 63 is a plate that transmits the driving force of the elevating member 64 to the press portion 62.

The elevating member 64 is, for example, a cam and rotates in the Y direction to move up/down the suction cap 60 in the direction of height (Z direction) of the printing apparatus 1. Note that the elevating member 64 may move up/down the suction cap 60 using, for example, a cam that operates in synchronization with a rotating operation in the X direction. The elevating member 64 is not limited to the cam and may be a linear actuator, a solenoid, a cylinder, or the like.

At the time of the maintenance operation (to be described later), the suction unit 65 sucks ink from the printhead 3 via the absorber 600 by setting a negative pressure in the suction cap space. The suction unit 65 includes a communication path 650 that makes the suction cap space and an external space communicate with each other. The communication path 650 is, for example, a suction tube connected to the suction cap 60. The suction unit 65 includes a suction pump 651 that sets a negative pressure in the suction cap space via the communication path 650. In other words, the suction pump 651 is a pressure reducing pump that reduces the pressure of the suction cap space.

The printing apparatus 1 includes a waste liquid tank 7 in which waste ink discharged from the printhead 3 by setting a negative pressure in the suction cap space by the suction unit 65 is stored.

### Printing Operation

Next, the printing operation of the printing apparatus 1 will be explained. Upon receiving a printing operation instruction, the printing apparatus 1 pinches a printing medium by the conveyance roller 20 and the pinch rollers 21, and conveys part of the printing medium to a position where it faces the printhead 3.

Then, the printing apparatus 1 drives the elevating member 54 to move down the dry cap 50 in a direction opposite to the Z direction, thereby opening the dry cap 50. While reciprocating and scanning, in the X direction perpendicular to the printing medium conveyance direction, the carriage 40 on which the printhead 3 is mounted, the printing apparatus 1 discharges ink from the orifice 31 to perform a printing operation of one line on the printing medium.

The printing apparatus 1 performs a conveyance operation for one line of the printing medium by rotating the conveyance roller 20 in a direction indicated by an arrow A in FIG. 1. The printing apparatus 1 repeats the printing operation and the conveyance operation a necessary number of times. After the printing apparatus 1 ends printing on the printing medium, it ejects the printing medium to an ejection portion (not shown) such as a tray.

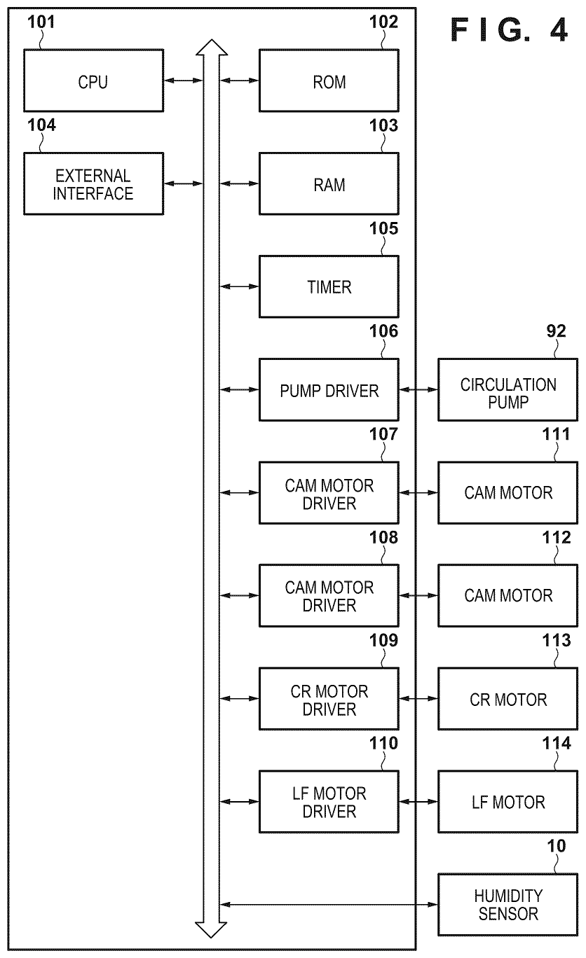

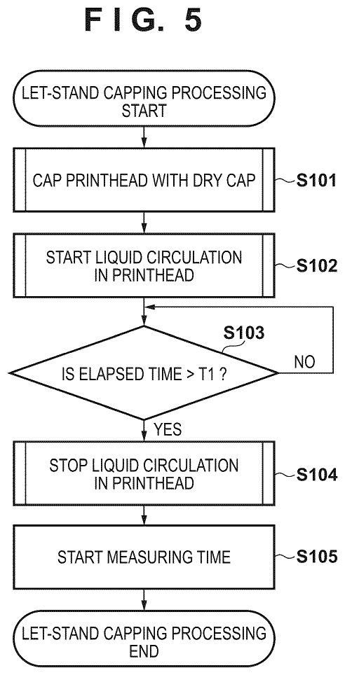

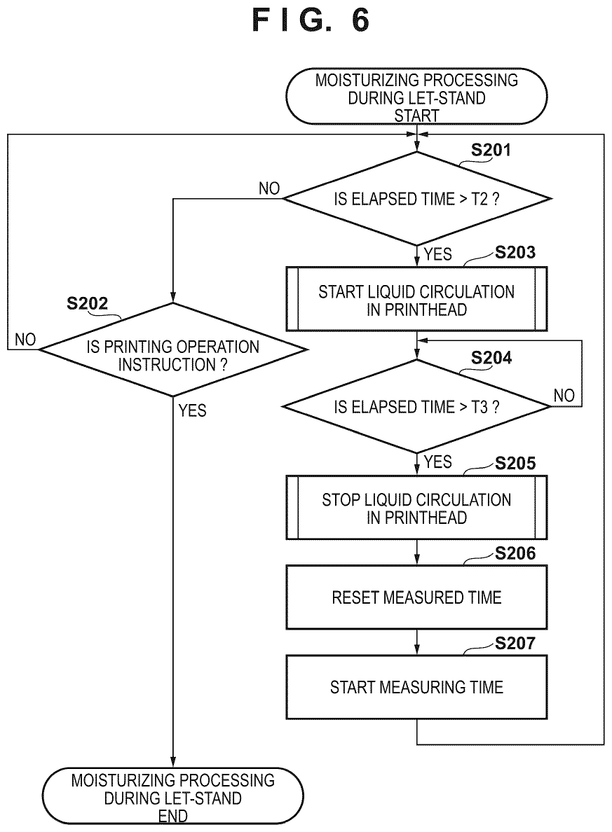

If the printing apparatus 1 ends the printing operation, it moves the carriage 40 to a position (above the dry cap 50) where the carriage 40 faces the dry cap 50. Then, a series of printing operations by the printing apparatus 1 is completed. After that, the printing apparatus 1 drives the elevating member 54 to move up the dry cap 50 and bring it into contact with the discharge surface 30, thereby capping the printhead 3. Note that an operation when the printing apparatus 1 caps the printhead 3 with the dry cap 50 will be explained later (see FIGS. 5 and 6).

### Maintenance Operation

Next, the maintenance operation of the printhead 3 will be explained. The printing apparatus 1 performs a maintenance operation to maintain high the ink discharge performance of the printhead 3. The maintenance operation includes, for example, a suction operation executed by the suction unit 65 to fill the printhead 3 with ink, and a preliminary discharge operation performed at the time of maintenance of the printhead 3 or before executing the printing operation. By the maintenance operation, the printing apparatus 1 can prevent clogging of the orifice 31 of the printhead 3 or the like with ink.

For example, when the printing apparatus 1 executes the suction operation as the maintenance operation, it moves the carriage 40 to move the printhead 3 to a position (above the suction cap 60) where the printhead 3 faces the suction cap 60. The printing apparatus 1 drives the elevating member 64 to move up the suction cap 60 in the Z direction and bring the suction cap 60 into contact with the discharge surface 30, thereby capping the printhead 3.

Then, the printing apparatus 1 closes the on-off valve 610, and drives the suction pump 651 to set a negative pressure in the suction cap space surrounded by the suction cap 60 and the printhead 3, and suck ink from the orifice 31 of the printhead 3.

While sucking out waste ink ejected into the suction cap 60 to the waste liquid tank 7 by the suction pump 651, the printing apparatus 1 opens the on-off valve 610 in a state in which the discharge surface 30 is capped with the suction cap 60. In response to this, air enters the suction cap space from the external space through the communication path 611, and the waste ink in the suction cap space is replaced with air. The sucked-out waste ink is stored in the waste liquid tank 7.

After that, the printing apparatus 1 drives the elevating member 64 to move down the suction cap 60 in a direction opposite to the Z direction, and open the suction cap 60. The printing apparatus 1 wipes the discharge surface 30 of the printhead 3 with a wiper blade (not shown). This is the suction operation.

Next, the preliminary discharge operation will be explained. When the printing apparatus 1 performs the preliminary discharge operation, it moves the printhead 3 to a position where it faces the suction cap 60 in a state in which the suction cap 60 is open. The printing apparatus 1 discharges ink from the printhead 3, and the discharged waste ink is received in the suction cap 60. After the end of preliminary discharge, the printing apparatus 1 drives the suction pump 651 in a state in which the on-off valve 610 is open, and stores the waste ink in the waste liquid tank 7.

The absorber 600 is used in both the suction operation and the preliminary discharge operation. For example, in the suction operation and the preliminary discharge operation, the capillary force of the absorber 600 is used to eject, to the waste liquid tank 7 by driving of the suction pump 651, ink discharged from the printhead 3 to the suction cap 60. The ink discharged from the printhead 3 is absorbed in the absorber 600. This can prevent the ink discharged to the suction cap 60, from rebounding in the suction cap 60 and attaching to the discharge surface 30.

In actual, when waste ink absorbed in the absorber 600 is ejected to the waste liquid tank 7 by the suction unit 65, a small amount of waste ink remains in the absorber 600. If, for example, the suction cap 60 is opened in a state in which the waste ink remains in the absorber 600, in order to perform the printing operation by the printing apparatus 1, the absorber 600 is exposed to the atmosphere. That is, the absorber 600 is in contact with air during the printing operation. In the state in which the absorber 600 is exposed to the atmosphere, water contained in the waste ink remaining in the absorber 600 evaporates. Then, a residual component such as a nonvolatile solvent component or solid component contained in the waste ink remains in the absorber 600. Such a residual component sometimes contains a water absorbing solvent component.

For example, a case where the printhead 3 is capped with the suction cap 60 and let stand will be assumed. In such a case, the water absorbing solvent component remaining in the absorber 600 acts as a water absorbing material and absorbs water in ink from the orifice 31 of the printhead 3. As a result, the ink of the printhead 3 can dry, thicken, and fix.

For example, a case where ink is discharged from the printhead 3 to moisturize the absorber 600 in order to prevent the solvent component from acting as a water absorbing material when the printhead 3 is capped with the suction cap 60 and let stand will be assumed. In this case, ink is unnecessarily consumed. Further, the waste liquid tank needs to be large.

A case where the printing apparatus 1 includes, for example, a mechanism of supplying, to the intra-cap space, a water vapor generated from a moisturizing liquid will be assumed. In such a case, the arrangement of the printing apparatus 1 becomes large, and the moisturizing liquid is used as a consumable in addition to ink.

Hence, some ingenuity is required to suppress drying of ink in the printhead 3 when the printhead 3 is let stand. According to the embodiment, when the printhead 3 is let stand, the printing apparatus 1 covers the discharge surface 30 with the dry cap 50 having no absorber 600 for receiving ink. In a state in which the discharge surface 30 is covered with the dry cap 50, the printing apparatus 1 circulates ink in the printhead 3 by a circulation unit 9 (to be described later). With this form, when the printhead 3 is capped, the water of ink in the printhead 3 is not absorbed by a residual component remaining in the absorber 600. By circulating ink in the printhead 3, the dry cap space 5S can be kept at high humidity to suppress drying of the ink on the discharge surface 30, which will be described later. That is, drying of ink in the printhead 3 can be suppressed.

### Capping and Circulating Operations

Next, a capping operation for the printhead 3 with the dry cap 50 and a circulating operation by the circulation unit 9 will be explained.

FIG. 2 is a schematic view for explaining the inside of the printhead 3 according to the embodiment. In FIG. 2, a dotted line represents the inside of the printhead 3 mounted on the carriage 40 (this also applies to FIG. 1).

The printing apparatus 1 includes a containing portion 8 and the circulation unit 9. The containing portion 8 is a sub-tank in which ink supplied from an ink tank (not shown) is contained. The circulation unit 9 communicates with the orifice 31, and circulates ink through a circulation path 90 including the containing portion 8 in which ink discharged from the orifice 31 is contained. More specifically, the circulation unit 9 performs a circulating operation of circulating ink through the circulation path 90 in a state in which the dry cap 50 covers the discharge surface 30, which will be described later.

The circulation unit 9 includes an on-off valve 91 that opens/closes the circulation path 90, and a circulation pump 92 that circulates ink through the circulation path 90. The pressure of ink in the containing portion 8 is adjusted by opening/closing of the on-off valve 91 and driving of the circulation pump 92. The circulation path 90 includes a channel formed between the containing portion 8 and the orifice 31 via the on-off valve 91, and a channel formed between the orifice 31 and the containing portion 8 via the circulation pump 92. The containing portion 8 is included in part of the circulation path 90. For example, in a circulating operation (to be described later), the printing apparatus 1 can drive the circulation pump 92 to circulate ink in the printhead 3 in a B direction in FIG. 2 through the circulation path 90.

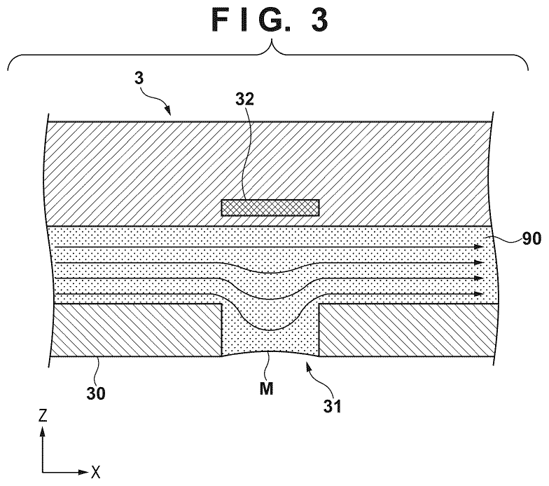

The state of ink in the printhead 3 will be explained with reference to FIG. 3. FIG. 3 is a schematic view showing the inside of the printhead 3, and is equivalent to an enlarged view of the periphery of the orifice 31. FIG. 3 shows a state in which a meniscus M of ink is formed at the orifice 31 owing to the surface tension of the ink. Note that when the discharge surface 30 is viewed from the bottom (printing medium side), the shape of the orifice 31 is a circle.

The printing apparatus 1 drives the circulation pump 92 to circulate ink in the circulation path 90. That is, ink flows within the printhead 3. The circulation pump 92 causes the ink to flow within the circulation path 90 so that the pressure becomes higher than a set pressure of the on-off valve 91. Thus, the pressure of the ink in the orifice 31 is negative, and the meniscus M formed at the orifice 31 has a shape recessed toward the outside of the orifice 31. In the circulating operation, the ink flows like flow lines shown in FIG. 3. By such a circulating operation, the meniscus M is formed at the orifice 31 by the ink supplied from the containing portion 8.

A case where the discharge surface 30 is covered with the dry cap 50 to cap the orifice 31 will be exemplified. As described above, the dry cap 50 does not include the absorber 600 for receiving ink, and the residual component of waste ink absorbed in the absorber 600 does not remain, unlike the suction cap 60. Therefore, water in ink within the printhead 3 is not absorbed in a water absorbing solvent component or the like. However, when the orifice 31 is covered with the dry cap 50, the meniscus M of the ink is exposed to air in the dry cap space 5S. For example, when the relative humidity of air in the dry cap space 5S is lower than a saturated water vapor pressure, the water vapor of the ink is kept released from the meniscus M until the relative humidity of air reaches the saturated water vapor pressure. For example, when no ink is supplied from the containing portion 8 to the orifice 31, water in ink evaporates from the meniscus M, and ink near the orifice 31 starts drying and can thicken and fix.

According to the embodiment, drying of ink in the orifice 31 is prevented by increasing the humidity in the dry cap space 5S by the circulating operation and let-stand the printhead 3 at substantially the saturated water vapor pressure in a state in which the orifice 31 is covered with the dry cap 50.

More specifically, when the printhead 3 is capped with the dry cap 50, ink that is contained in the containing portion 8 and fully contains water is supplied by the circulating operation, releasing the water from the meniscus M. This makes the inside of the dry cap space 5S come close to the saturated water vapor pressure. Since the inside of the dry cap space 5S becomes close to the saturated water vapor pressure, evaporation of water from the meniscus M surface can be prevented. Once the inside of the dry cap space 5S becomes a high-humidity state by this operation, the high-humidity state can be maintained even after circulation of ink is stopped.

Note that the communication path 51 is provided in the dry cap 50. For example, when the inside of the dry cap space 5S is made completely airtight, air in the dry cap space 5S can expand or contract depending on a change of the temperature or air pressure of an environment where the printing apparatus 1 is installed. As a result, air may be compressed into the orifice 31 or ink may be drawn from the orifice 31. Hence, the internal pressure of the dry cap space 5S and the pressure of the external space are equalized via the communication path 51 to prevent a change of the pressure of the dry cap space 5S when the orifice 31 is capped with the dry cap 50.

Note that the communication path 51 is long in terms of suppressing a decrease in the humidity of the dry cap space 5S when the discharge surface 30 is capped with the dry cap 50. For example, the communication path 51 may be configured to be longer than the communication path 611. Alternatively, for example, the inner diameter of the communication path 51 may be configured to be smaller than that of the communication path 611.

Note that the humidity in the dry cap space 5S can decrease over time depending on the water vapor permeation of the dry cap 50 or the like. In terms of suppressing a decrease in humidity within the dry cap space 5S, ink is circulated to increase the humidity in the dry cap space 5S a predetermined time after capping the discharge surface 30 with the dry cap 50. Such a periodic circulating operation can be performed to prevent drying of ink in the orifice 31 even when, for example, the printhead 3 is let stand for a long period.

Next, FIG. 4 will be referred to. FIG. 4 is a block diagram showing the control system and hardware of the printing apparatus 1.

The printing apparatus 1 includes a CPU 101 that controls the overall operation of the printing apparatus 1 including the operation of each building component and data processing, and a ROM 102 in which various programs to be executed by the CPU 101 and various data are stored. The printing apparatus 1 also includes a RAM 103 in which processing data and the like to be executed by the CPU 101 are temporarily stored. The printing apparatus 1 includes an external interface 104. The external interface 104 is connected to, for example, an external apparatus (not shown), and receives printing data and various commands from the external apparatus.

The printing apparatus 1 includes a timer 105 that measures the time. In processing (to be described later), the CPU 101 uses the timer 105 to measure the time after starting circulation of ink, the time after stopping the circulation of ink, or the like.

The printing apparatus 1 includes a pump driver 106 that controls driving of the circulation pump 92, and a cam motor driver 107 that controls driving of the elevating member 54. The pump driver 106 is connected to the circulation pump 92, and controls driving of the circulation pump 92. The cam motor driver 107 is connected to a cam motor 111 that drives the elevating member 54, and controls driving of the cam motor 111. The printing apparatus 1 includes a cam motor driver 108. The cam motor driver 108 is connected to a cam motor 112 that drives the elevating member 64, and controls driving of the cam motor 112.

The printing apparatus 1 includes a CR motor driver 109 that controls driving of a CR motor, an LF motor driver 110 that controls driving of an LF motor 114, a humidity sensor 10, and the like.

Next, FIG. 5 will be referred to. FIG. 5 is a flowchart showing an example of let-stand capping processing executed when the printhead 3 is let stand. The processing in FIG. 5 may be started after, for example, the printing apparatus 1 ends the printing operation. Alternatively, the processing in FIG. 5 may be started when, for example, the maintenance operation of the printhead 3 ends. The processing in FIG. 5 is implemented by, for example, reading out to the RAM 103 a program stored in the ROM 102 serving as a computer-readable recording medium, and executing it by the CPU 101.

In step S101, the CPU 101 covers the discharge surface 30 with the dry cap 50. In other words, the CPU 101 caps the printhead 3 with the dry cap 50. More specifically, the CPU 101 drives the cam motor 111 via the cam motor driver 107 to rotate the elevating member 54 serving as a cam. By this processing, the dry cap 50 moves up in the Z direction, and the discharge surface 30 is covered with the dry cap 50. Water absorption of ink of the printhead 3 by a component such as a solvent remaining in the absorber 600 can be prevented by covering the discharge surface 30 with the dry cap having no absorber 600 for receiving ink.

In step S102, the CPU 101 performs the circulating operation to circulate ink in the printhead 3. More specifically, the CPU 101 drives the circulation pump 92 by control of the pump driver 106 to circulate ink in the circulation path 90. By this processing, a water vapor is released from the meniscus M into the dry cap space 5S, increasing the humidity of the dry cap space 5S. This can suppress drying of the ink of the printhead 3.

In step S103, the CPU 101 determines whether the time elapsed after starting the circulating operation has exceeded a time T1. If the CPU 101 determines that the time has exceeded the time T1, it advances to step S104. If the CPU 101 determines that the time has not exceeded the time T1, it repeats step S103. In the embodiment, the printing apparatus 1 adopts, as a circulating operation stop condition, the lapse of the predetermined time T1 after starting the circulating operation. That is, in the embodiment, the printing apparatus 1 performs management of increasing the humidity of the dry cap space 5S to a target value based on the time elapsed after starting circulation of ink.

According to the embodiment, the CPU 101 performs management so that the humidity of the dry cap space 5S reaches the target value by continuing circulation of ink for the predetermined time T1. In other words, the circulating operation is stopped based on a condition about a change of the humidity of the dry cap space 5S. Note that the CPU 101 obtains in advance data until the humidity reaches the target humidity after starting circulation, based on the humidity and temperature of an environment where the printing apparatus 1 is installed, and the capacity of the dry cap space 5S. Then, the CPU 101 sets the time T1.

In step S104, the CPU 101 stops the circulating operation by the circulation unit 9. More specifically, the CPU 101 stops driving of the circulation pump 92 via the motor driver. As a result of the above processing, the inside of the dry cap space 5S reaches the target humidity.

In step S105, the CPU 101 drives the timer 105 to start counting the stop time after stopping the circulating operation. For example, the humidity of the dry cap space 5S can gradually decrease after the circulating operation is stopped. In the embodiment, the stop time is counted to execute again the circulating operation when no printing operation instruction is received till a predetermined time elapsed after stopping the circulating operation. Then, the CPU 101 ends the let-stand capping processing operation.

Next, FIG. 6 will be referred to. FIG. 6 is a flowchart showing an example of moisturizing processing during let-stand. This processing is executed to return the humidity in the dry cap space 5S to a target humidity when the humidity in the dry cap space 5S decreases while the printhead 3 is capped with the dry cap 50 and let stand. The processing in FIG. 6 starts based on, for example, the end of the processing in FIG. 5 by the CPU 101. The processing in FIG. 6 is implemented by, for example, reading out to the RAM 103 a program stored in the ROM 102 serving as a computer-readable recording medium, and executing it by the CPU 101.

In step S201, the CPU 101 determines, based on the stop time measured by the timer 105, whether the time elapsed after stopping the circulating operation has exceeded a time T2. If the CPU 101 determines that the time has exceeded the time T2, it advances to step S203. If the CPU 101 determines that the time has not exceeded the time T2, it advances to step S202. In the embodiment, the circulating operation is restarted the predetermined time T2 elapsed after stopping the circulating operation in response to the lapse of the predetermined time T1. When the circulating operation is stopped, the humidity of the dry cap space 5S can decrease, so the CPU 101 checks whether the time has exceeded the predetermined time T2.

In step S202, the CPU 101 determines whether a printing operation instruction has been received. If the CPU 101 determines that a printing operation instruction has been received, it ends the processing in FIG. 6. If the CPU 101 determines that no printing operation instruction has been received, it returns to step S201.

In step S203, the CPU 101 performs the circulating operation to circulate ink in the printhead 3 by the circulation unit 9. In the embodiment, the circulating operation is restarted the time T2 elapsed after stopping the circulating operation in response to the lapse of the time T1. Note that the processing in step S203 is similar to that in step S102, and a description thereof will not be repeated.

In step S204, the CPU 101 determines whether the time elapsed after starting circulation of ink has exceeded a time T3. If the CPU 101 determines that the time has exceeded the time T3, it advances to step S205. If the CPU 101 determines that the time has not exceeded the time T3, it repeats step S204. Note that the processing in step S204 is similar to that in step S103, and a description thereof will not be repeated.

In step S205, the CPU 101 stops the circulating operation of ink by the circulation unit 9. Note that the processing in step S205 is similar to that in step S104. By the above processing, the inside of the dry cap space 5S returns to the target humidity.

In step S206, the CPU 101 resets the time measured by the timer 105. This processing is performed to manage again the humidity in the dry cap space 5S.

In step S207, the CPU 101 starts counting the let-stand time by the timer 105. This processing is performed similarly to step S105. Thereafter, the CPU 101 executes again the processing in step S201 to continue humidity management in the dry cap space 5S. The CPU 101 continues moisturizing processing during let-stand until it confirms in step S202 that a printing operation instruction has been received.

As described above, according to the embodiment, when let-stand the printhead 3, the printing apparatus 1 covers the discharge surface 30 with the dry cap 50 having no absorber for receiving ink. Covering the discharge surface 30 with the dry cap 50 can suppress drying of ink of the printhead 3 caused by a residual component such as a water absorbing solvent or the like remaining in the absorber 600. The printing apparatus 1 performs the circulating operation of circulating ink by the circulation unit 9 through the circulation path 90 in a state in which the discharge surface 30 is covered with the dry cap 50. Such a circulating operation can increase the humidity of the dry cap space 5S to suppress drying of ink attached to the discharge surface 30. That is, the embodiment can provide a technique of suppressing drying of ink in the printhead 3 when the printhead 3 is capped.

Although the humidity of the dry cap space 5S is increased by circulating ink in the printhead 3 by the circulation unit 9 in the embodiment, the present disclosure is not limited to this. For example, when the printhead 3 is capped with the dry cap 50, ink in the printhead 3 may be oscillated to increase the humidity of the dry cap space 5S. For example, the energy generation element 32 or the like may be finely oscillated to convect ink forming the meniscus M. The arrangement in which the circulation unit 9 is provided inside the printhead 3 has been explained. However, the present disclosure is not limited to this and is also applicable to an arrangement in which the circulation unit 9 is provided outside the printhead 3 (for example, in the middle of a supply channel).

Note that the printing method of the printhead 3 is a serial scan method in the embodiment, but the present disclosure is not limited to this. For example, the printing method of the printhead 3 may be a full-line method. In the full-line method, a printhead 3 long in the X direction is used, and an image is printed while successively conveying a printing medium. Even in the case where the printing method of the printhead 3 is the full-line method, when let-stand the printhead 3, it may be capped using the dry cap 50.

In some cases, part of ink discharged from the orifice 31 remains attached to the discharge surface 30 of the printhead 3. When the discharge surface 30 is capped with the dry cap 50, the ink attached to the discharge surface 30 may be transferred to, for example, a portion of the dry cap 50 that comes into contact with the discharge surface 30. In some cases, part of ink discharged from the printhead 3 floats as mist in the printing apparatus 1 during the printing operation. The ink mist may attach to the dry cap 50. For example, if such a small amount of ink attaches to the dry cap 50 and dries and the printhead 3 is capped with the dry cap 50, this hardly influences ink of the printhead 3. That is, attachment of a small amount of ink to the dry cap 50 does not depart from the gist of the present disclosure. The dry cap 50 is a cap not accompanied by ink discharge in the printing operation and the maintenance operation, and can prevent ink from drying and acting as an absorber.

### Second Embodiment

Next, a difference of the second embodiment from the first embodiment will be described. In the first embodiment, the humidity in the dry cap space 5S is managed based on the time elapsed after stopping the circulating operation. In the second embodiment, a printing apparatus 1 manages the humidity in a dry cap space 5S using a humidity sensor 10.

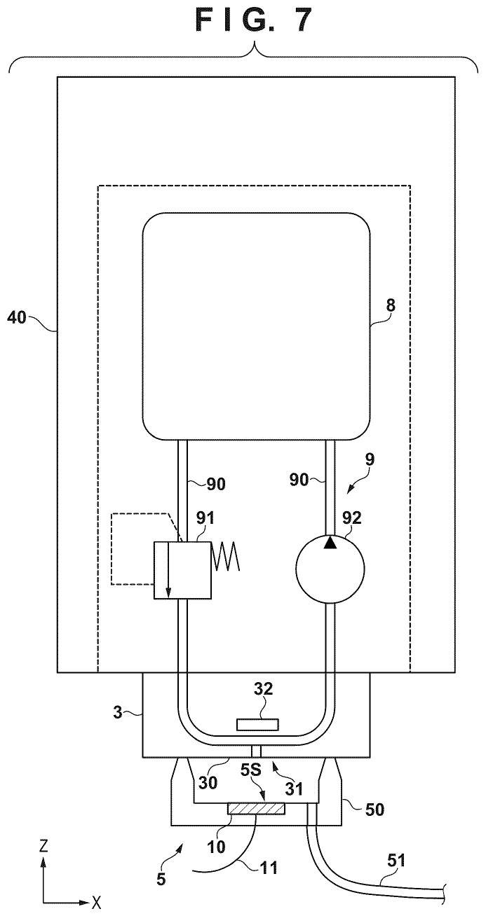

FIG. 7 is a schematic view for explaining a dry cap 50 according to the embodiment. In the embodiment, the printing apparatus 1 includes the humidity sensor 10 that is provided in the dry cap 50 and measures the humidity of the dry cap space 5S. A sensor harness 11 is connected to the humidity sensor 10. The sensor harness 11 is provided through the dry cap 50. The electrical signal of the humidity sensor 10 is transmitted outside the sensor harness 11. A CPU 101 obtains via the sensor harness 11 a change of the humidity of the dry cap space 5S that is detected by the humidity sensor 10. The dry cap 50 and the sensor harness 11 are in close contact with each other. This can prevent leakage of air of the dry cap space 5S to the outside from a portion at which the sensor harness 11 extends through the dry cap 50.

The humidity sensor 10 may be, for example, a capacitive sensor that measures a humidity by measuring a capacitance between electrodes sandwiching a polymer membrane that adsorbs and release water. The humidity sensor 10 may be a resistive sensor that uses a polymer membrane whose resistance value changes depending on adsorption/release of water. Note that a polymer membrane that is hardly influenced by a solvent contained in ink is used. Note that a temperature-humidity sensor capable of measuring the temperature and humidity of the dry cap space 5S may be used.

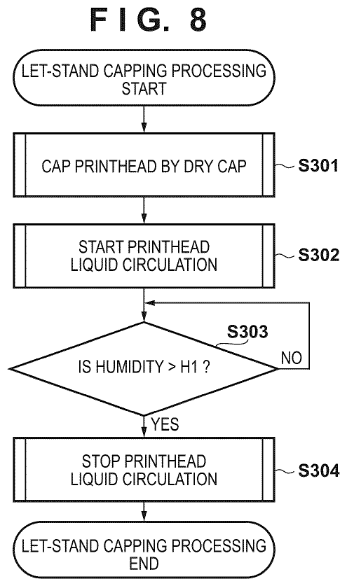

FIG. 8 is a flowchart showing an example of let-stand capping processing executed when a printhead 3 is let stand. The processing in FIG. 8 may be started after, for example, the printing apparatus 1 ends the printing operation. Alternatively, the processing in FIG. 8 may be started when, for example, the maintenance operation of the printhead 3 ends. The processing in FIG. 8 is implemented by, for example, reading out to a RAM 103 a program stored in a ROM 102 serving as a computer-readable recording medium, and executing it by the CPU 101.

Processes in steps S301 and S302 are performed similarly to those in steps S101 and S102.

In step S303, the CPU 101 determines whether the humidity of the dry cap space 5S measured by the humidity sensor 10 has exceeded a preset target value H1. If the CPU 101 determines that the humidity has exceeded the target value H1, it advances to step S304. If the CPU 101 determines that the humidity has not exceeded the target value H1, it repeats the processing in step S303. In the embodiment, the printing apparatus 1 adopts, as a circulating operation stop condition, a state in which the humidity of the dry cap space 5S measured by the humidity sensor 10 has reached the target value H1. In other words, the circulating operation is stopped based on a condition about a change of the humidity of the dry cap space 5S. Note that the target value H1 is similar to that described in step S103, and a description thereof will not be repeated.

Processing in step S304 is performed similarly to step S104. In the embodiment, the CPU 101 ends the let-stand capping processing.

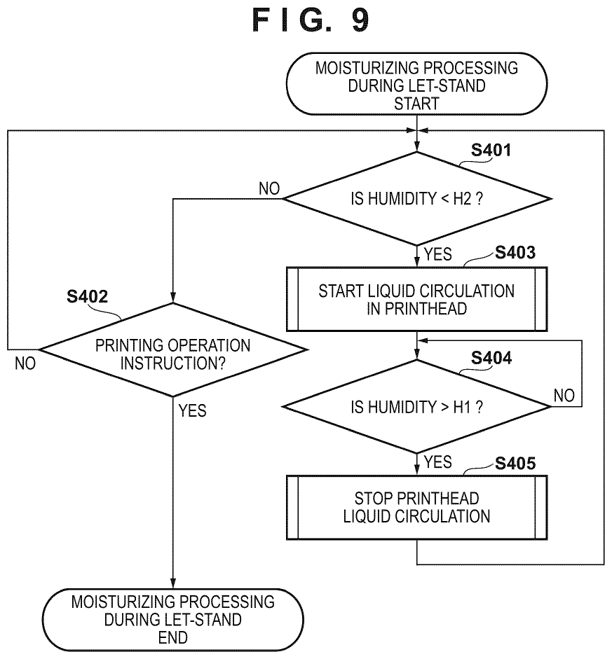

Next, FIG. 9 will be referred to. FIG. 9 is a flowchart showing an example of moisturizing processing during let-stand. This processing is executed to return the humidity in the dry cap space 5S to a target humidity when the humidity in the dry cap space 5S decreases while the printhead 3 is capped with the dry cap 50 and let stand. The processing in FIG. 9 starts based on, for example, the end of the processing in FIG. 8 by the CPU 101. The processing in FIG. 9 is implemented by, for example, reading out to the RAM 103 a program stored in the ROM 102 serving as a computer-readable recording medium, and executing it by the CPU 101.

In step S401, the CPU 101 measures the humidity in the dry cap space 5S by the humidity sensor 10. Then, the CPU 101 determines whether the humidity in the cap space is lower than a lower limit value H2. If the CPU 101 determines that the humidity in the cap space is lower than the lower limit value H2, it advances to step S403. If the CPU 101 determines that the humidity in the cap space is not lower than the lower limit value H2, it advances to step S402.

The lower limit value H2 is a value lower than the target value H1. By setting the lower limit value H2 in this manner, drying of ink in the printhead 3 can be further suppressed.

In step S402, the CPU 101 determines whether a printing operation instruction has been received. If the CPU 101 determines that a printing operation instruction has been received, it ends the processing in FIG. 9. If the CPU 101 determines that no printing operation instruction has been received, it returns to step S401.

In step S403, the CPU 101 performs the circulating operation to circulate ink in the printhead 3 by a circulation unit 9. That is, in the embodiment, the circulating operation is restarted when the humidity of the dry cap space 5S measured by the humidity sensor 10 has reached the lower limit value H2 after stopping the circulating operation when the humidity reaches the target value H1. The processing in step S403 is performed similarly to steps S102 and S203.

In step S404, the CPU 101 measures the humidity in the dry cap space 5S that is measured by the humidity sensor 10. Then, the CPU 101 determines whether the humidity of the cap space has exceeded the target value H1. If the CPU 101 determines that the humidity has exceeded the target value H1, it advances to step S405. If the CPU 101 determines that the humidity has not exceeded the target value H1, it repeats step S404. This processing is performed similarly to step S303.

In step S405, the CPU 101 stops the liquid circulating operation. This processing is performed similarly to step S104. After that, the CPU 101 returns to step S401 to continue humidity management in the dry cap space 5S. The CPU 101 continues moisturizing processing during let-stand until it confirms in step S402 that a printing operation instruction has been received.

As described above, according to the embodiment, when let-stand the printhead 3, the printing apparatus 1 controls execution of the circulating operation based on the humidity of the dry cap space 5S measured by the humidity sensor 10. Hence, when let-stand the printhead 3, a change of the humidity of the dry cap space 5S can be properly managed to suppress drying of ink. By measuring the humidity by the humidity sensor 10, the driving time of a circulation pump 92 can be shortened to reduce the power consumption of the printing apparatus 1.

### Third Embodiment

Another example of the arrangement of a printing apparatus 1 will be explained with reference to FIGS. 11A and 11B. The communication path 51 is exemplified as a tube connected to the dry cap 50 in the first and second embodiments, but is not limited to this. For example, as shown in FIG. 11A, a communication path 51 may be formed inside a dry cap 50. FIG. 11A is a plan view of the dry cap 50 and is equivalent to a view when the dry cap 50 is viewed from a printhead 3 side. The dry cap 50 has an opening 511 formed on a dry cap space 5S side. FIG. 11B is a bottom view of the dry cap 50 and is equivalent to a view when the dry cap 50 is viewed from a printing medium side. The dry cap 50 has an opening 512 formed on an external space side. In FIGS. 11A and 11B, dotted lines represent a communication path 51 formed inside the dry cap 50. The communication path 51 makes an opening 510 on the dry cap space 5S side and the opening 511 on the external space side communicate with each other inside the dry cap 50. The communication path 51 has a labyrinth shape. More specifically, for example, the communication path 51 is formed by bending it a plurality of times inside the dry cap 50. The communication path 51 having a labyrinth shape can increase the distance from the opening 511 on the dry cap space 5S side to the opening 512 on the external space side. This can suppress a decrease in the humidity of the dry cap space 5S. Note that a tube serving as the communication path 51 may be further connected to the opening 511, as in the first and second embodiments.

### Fourth Embodiment

Ink in a cap sometimes drips at an unexpected timing owing to a shock, a temperature change, or the like. When ink droops in the cap, it is difficult to obtain an accurate evaporation ratio. If the evaporation ratio is not accurate, no proper circulation can be performed, and insufficient circulation may generate a discharge failure or excessive circulation may impair the usability of the user.

In the embodiment, a liquid discharge apparatus and control method capable of suppressing generation of a discharge failure and suppressing thickening of ink at an orifice without impairing the usability of the user will be described.

The fourth embodiment of the present disclosure will be explained with reference to the accompanying drawings.

FIG. 12 is a perspective view showing the outer appearance of a liquid discharge apparatus (to be also simply referred to as a printing apparatus) 1201 according to the embodiment. The liquid discharge apparatus 1201 is a so-called serial scan printer that moves a printhead 1210 in the X direction (scanning direction) perpendicular to the Y direction (conveyance direction) in which a printing medium 1203 is conveyed, and discharges a liquid to the printing medium, thereby printing an image.

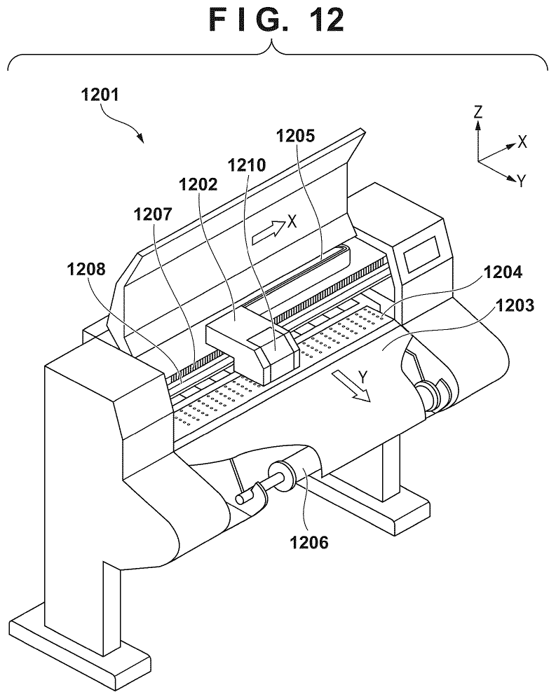

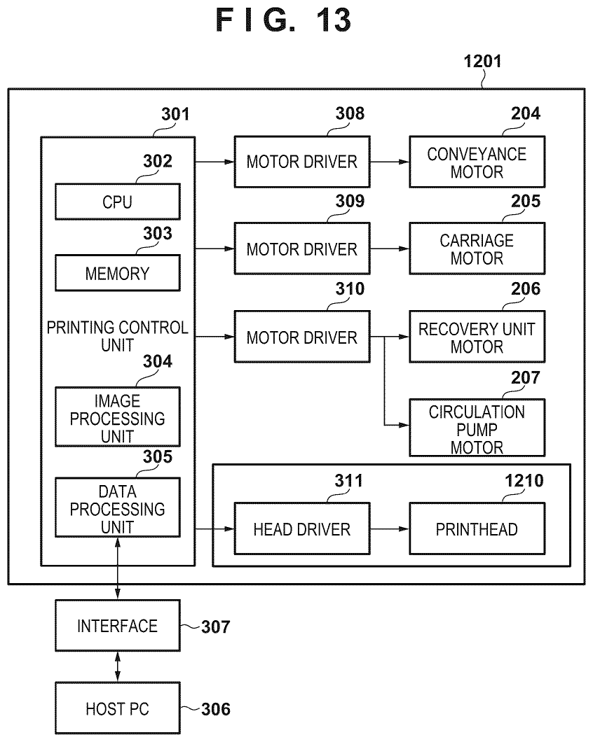

The arrangement of the printing apparatus 1201 and an outline of an operation at the time of printing will be explained. The printing medium 1203 is conveyed in the Y direction by a conveyance roller driven by a conveyance motor 204 (see FIG. 13 to be described later) via a gear, and the printing medium 1203 after printing is rolled up by a spool 1206 and held.

At a predetermined conveyance position, a carriage motor 205 (see FIG. 13 to be described later) moves a carriage unit 1202 to reciprocate along a guide shaft 1208 extending in the X direction. The printhead 1210 is mounted on the carriage unit 1202, and moves to scan together with the carriage unit 1202. During the scanning, a liquid is discharged from the orifice of the printhead 1210 at a timing based on a position signal obtained by an encoder 1207, thereby printing on the printing medium 1203 by a predetermined band width corresponding to an orifice array range. Then, the printing medium 1203 is conveyed, and printing of the next band width is further performed on the printing medium 1203. In this manner, conveyance of the printing medium 1203 and scanning of the printhead 1210 are alternately repeated, completing printing.

At the start of printing, the end of the rolled-up printing medium 1203 is pulled out and supplied. The supplied printing medium 1203 is pinched and conveyed by a paper feed roller and a pinch roller, and guided to a printing position (printhead scan area) on a platen 1204. Generally, in the idle state of the printing apparatus 1201, an orifice surface on which the orifice of the printhead 1210 is provided is capped with a let-stand cap 501 (see FIG. 21 to be described later) of a let-stand unit 510 (see FIG. 21 to be described later). Prior to printing, the printhead 1210 is released from capping with the let-stand cap 501 so that it can scan. After data of one scanning is accumulated in a buffer, the carriage motor 205 moves the carriage unit 1202 to scan on the printhead 1210, and printing is performed in the above-described way.

Note that a driving force can be transmitted from the carriage motor 205 to the carriage unit 1202 using a carriage belt. However, instead of the carriage belt, another driving mechanism may be used, such as a mechanism including a lead screw that extends in the X direction and is driven to rotate by the carriage motor 205, and an engaging portion that is provided on the carriage unit 1202 and engages with the groove of the lead screw.

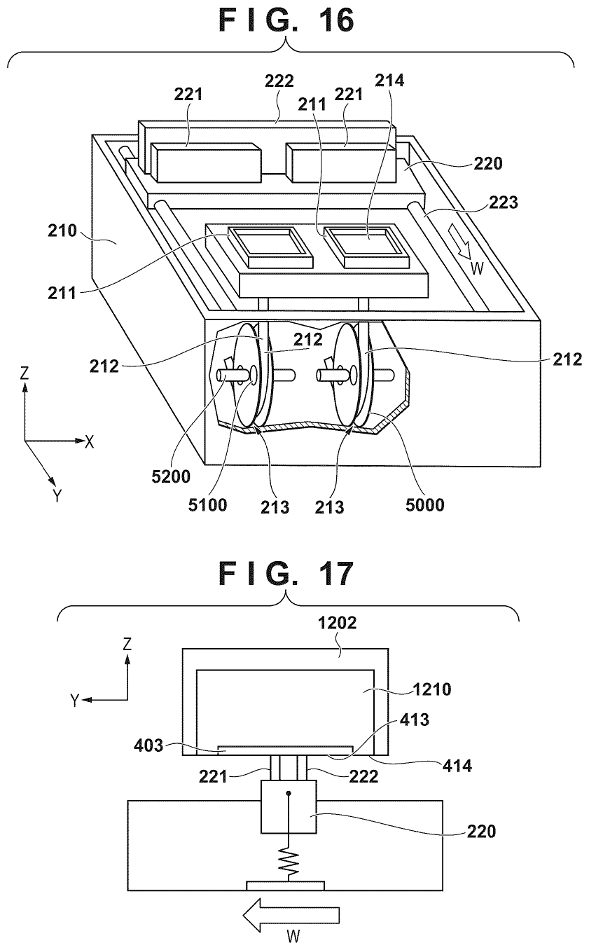

A liquid (to be also referred to as ink hereinafter) is supplied to the printhead 1210 through a supply tube 1205 via the carriage unit 1202 from inside the main body or from an ink tank 202 (see FIG. 18 to be described later) mounted on an external unit. Ink may be supplied from the ink tank 202 to the printhead 1210 using a pressure unit. Ink may also be supplied from the ink tank 202 by capping, with recovery caps 211 (see FIG. 16 to be described later) of a recovery unit (to be described later), the orifice surface on which the orifices of the printhead 1210 are provided, and applying a negative pressure to the inside of the cap by a suction pump to suck the ink. One printhead or a plurality of printheads capable of discharging inks of a plurality of colors may be mounted on the carriage, or one printhead capable of discharging inks of a plurality of colors may be mounted on the carriage.

FIG. 13 is a block diagram showing the arrangement of a printing control system in the printing apparatus 1201. The printing apparatus 1201 is connected to a data supply apparatus such as a host computer (to be referred to as a host PC hereinafter) 306 via an interface 307. Various data, control signals regarding printing, and the like transmitted from the host PC 306 are input to a printing control unit 301 of the printing apparatus 1201. The printing control unit 301 includes a memory 303 in which input image data, multi-value data of an intermediate product, and a multi-pass mask are stored, and a CPU 302 (or ASIC) serving as a control arithmetic device. The printing control unit 301 includes a data processing unit 305 for processing data input via the interface 307, and an image processing unit 304 that performs predetermined image processing on input image data to generate an image signal printable by the printhead 1210. The printing control unit 301 controls motor drivers and a head driver (to be described later) in accordance with a control signal and image signal after processing.

The conveyance motor 204 is a motor that drives and rotates a conveyance roller for conveying the printing medium 1203. The carriage motor 205 is a motor that drives and reciprocates a carriage on which the printhead 1210 is mounted. A recovery unit motor 206 is a motor mounted on a recovery unit 210, switches a unit to be driven by a cam shaft, operates a wiper holder 220 and suction pumps 213, and moves up and down a recovery cap and let-stand cap (to be described later). A circulation pump motor 207 drives mechanisms contributing to ink circulation, such as a pump 408 (see FIG. 18 to be described later) of the printhead 1210. A motor driver 308 is a driver that drives the conveyance motor 204, a motor driver 309 is a driver that drives the carriage motor 205, and a motor driver 310 is a driver that drives the recovery unit motor 206 and the circulation pump motor 207. A head driver 311 is a driver that drives the printhead 1210, and when a plurality of printheads are mounted, a plurality of head drivers 311 are provided in correspondence with the number of printheads.

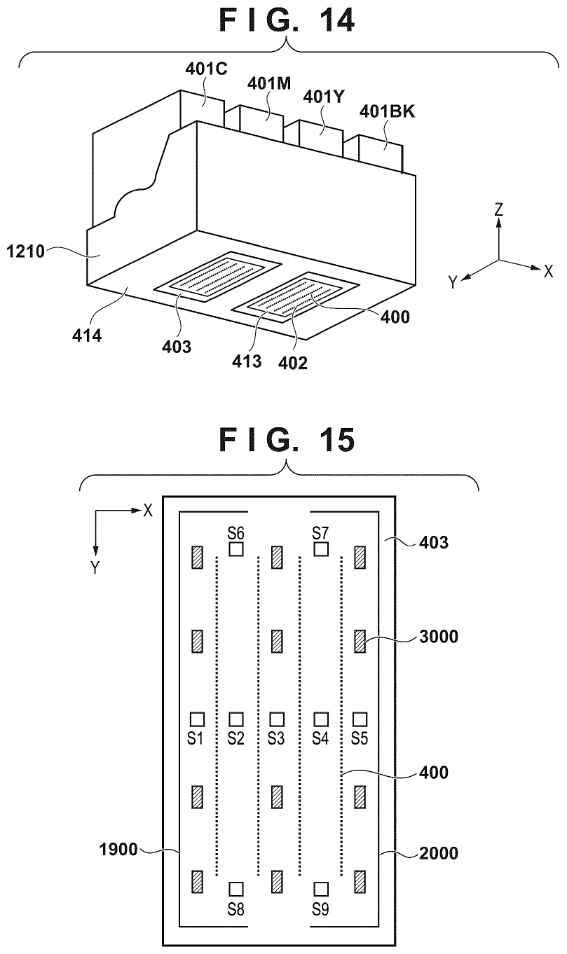

FIG. 14 is a view showing an example of the printhead 1210 and an orifice group arrangement. The printhead 1210 includes independent buffer tanks 401C, 401M, 401Y, and 401BK for four, cyan, magenta, yellow, and black inks. Although the buffer tanks are visible in FIG. 14 for descriptive convenience, they are incorporated in the printhead 1210. Chips 403 on which orifice arrays corresponding to the respective inks are formed are arranged on the lower surface of the printhead 1210. On each chip 403, two arrays each of 1,024 orifices 402 formed at an interval of 1,200 dpi per color are juxtaposed, and two colors can be discharged by one chip. By arranging two chips, four-color printing becomes possible.

Note that orifice arrays 400 corresponding to one color need not be arranged on the same straight line, and a total of four orifice arrays 400 on each of which 512 orifices 402 are arrayed at an interval of 600 dpi may be arranged so that they are staggered from each other. The number of ink colors supported by the printhead 1210 is not limited to four, and may be larger or smaller.

The printhead 1210 has orifice surfaces 413 on which the orifices 402 are arranged on the chips 403, and a face surface 414 that includes the orifice surfaces 413 and faces a printing medium at the time of printing.

FIG. 15 is a plan view showing the chip 403. Temperature sensors S6, S7, S8, and S9 each constituted by a diode for detecting the temperature of the chip 403 are formed along sides of the chip 403 on which two ends of the orifice array 400 are positioned. The temperature sensors S6 to S9 are located at positions about 0.2 mm apart from the outermost orifice positions of the orifice array 400 in the sub-scanning direction (Y direction), and each of the temperature sensors S6 to S9 is arranged at an intermediate position between two orifice arrays in the main scanning direction (X direction). Temperature sensors S1, S2, S3, S4, and S5 each constituted by a diode for detecting the temperature of the center of the chip 403 are formed at the center in the array direction of the orifices 402. Each of the temperature sensors S1, S2, S3, S4, and S5 is arranged at an intermediate position sandwiched between two orifice arrays 400.

Thermal heaters 1900 and 2000 are formed along the circumference of the chip 403, and positioned 1.2 mm outside the outermost orifice arrays in the main scanning direction (X direction) and 0.2 mm outside the temperature sensors S6, S7, S8, and S9 in the sub-scanning direction (Y direction). The overall size of the chip 403 is 9.55 mm in the X direction (also called a lateral direction)×39.0 mm in the Y direction (also called a longitudinal direction). Heating elements 3000 capable of heating the chip 403 are arranged on the chip 403. With this arrangement, temperature adjustment control is performed to heat ink to a predetermined temperature in order to suppress a change of the viscosity of ink in the printhead 1210, and keep the viscosity constant without being influenced by the environmental temperature. The thermal heaters 1900 and 2000 keep warm the chip 403 heated by the heating elements 3000. A driver (driving unit (not shown)) is arranged on the printhead 1210. The driver is connected to each heating element 3000 and configured to control ON/OFF of the driving current of the heating element 3000.

FIG. 16 is a perspective view showing the recovery unit 210. The recovery unit 210 includes the recovery caps 211, wipers 221 and 222, the wiper holder 220, guides 223, and the suction pumps 213. Each recovery cap 211 is supported by an elevating mechanism (not shown) so that it can be moved up/down, and is configured to be movable between an up position and a down position. At the up position, the recovery cap 211 contacts the printhead 1210 and covers (caps) the orifice surface 413 on which the orifices 402 of the printhead 1210 are provided. The recovery cap 211 can recover a discharge state by covering the orifice surface 413 of the printhead 1210, and driving the suction pump 213 to suck ink from the printhead 1210.

An absorber 214 capable of absorbing and holding a predetermined amount of ink is set in the recovery cap 211. Note that no recovery cap is used at the time of a non-printing operation because the orifice surface 413 is covered with a let-stand cap (to be described later) to suppress drying of ink in the orifices 402. At the time of the printing operation, the recovery cap 211 is located at the down position in order to avoid interference with the printhead 1210 moving together with the carriage 1202. In the state in which the recovery cap 211 is located at the down position, the printhead 1210 moves to a position where the orifice surfaces 413 face the recovery caps 211, and can perform preliminary discharge to discharge ink from the orifices 402 to the recovery caps 211.

The wipers 221 and 222 are made of an elastic member such as rubber. In the embodiment, the two wipers 221 that wipe the orifice surfaces 413 of the two chips 403 (see FIG. 14), and the wiper 222 that wipes the face surface 414 including the orifice surfaces 413 of the two chips 403 in the printhead 1210 are provided.

The wipers 221 and 222 are fixed to the wiper holder 220. The wiper holder 220 is configured to be movable along the guides 223 in the Y direction (array direction of the orifices 402 in the printhead) indicated by an arrow W. When the printhead 1210 is located at a standby position, the wiper holder 220 moves in the direction (one direction) indicated by the arrow W, and the wipers 221 and 222 can perform a wiping operation of wiping the orifice surfaces 413 while coming into contact with the orifice surface 413. After the end of the wiping operation, the carriage 1202 is moved and retracted from the area where the wiping operation is performed. Then, the wiper holder 220 is moved to return the wipers 221 and 222 to original positions (positions before the wiping operation).

In the embodiment, a tube pump is used as the suction pump 213. The tube pump includes a holding portion 5000 having a curved portion along which (at least part of) a tube 212 is conformed and held, a roller 5100 capable of pressing the held tube 212, and a roller support portion 5200 that rotatably supports the roller. The tube pump rotates the roller support portion in a predetermined direction to rotate the roller while pushing the tube 212. This generates a negative pressure in the recovery cap 211 to suck ink from the printhead 1210. The sucked ink is ejected to a waste ink absorber via the tube 212.

When a purge operation is performed on the recovery caps 211 by the printhead 1210, the suction operation is performed even in ejecting ink received in the recovery cap 211 by the purge operation. That is, when the purge operation is performed and ink held in the recovery caps 211 reaches a predetermined amount, the suction pumps 213 can be driven to eject the ink held in the recovery caps 211 to the waste ink absorber via the tubes 212. Note that it is difficult to completely eject the ink held in the recovery caps 211, so the ink always remains in the recovery caps 211 to a certain degree.

The suction pump 213 is driven in a state in which the recovery cap 211 covers the orifice surface 413 of the printhead 1210 to change the inside into an substantially airtight space. The suction pump 213 performs the suction operation to suck ink from the printhead 1210 by generating a negative pressure inside the recovery cap 211. The suction operation is performed in filling the inside of the printhead 1210 with ink from the ink tank 202 (at the time of initial filling), or in sucking and removing dust, a stuck material, bubbles, or the like in the orifice. The recovery cap 211 is connected to the waste ink absorber (not shown) via the flexible tube 212.

Note that, in the embodiment, the wipers 221 and 222 may be elastic members of rubber or the like, or members of a porous material that absorbs ink. A recovery operation using the elastic members will be explained with reference to FIG. 17.

FIG. 17 is a view showing the printhead 1210 and the wipers 221 and 222 of the recovery unit 210 at the time of wiping. The wipers 221 and 222 are moved in a direction (wiping direction) indicated by an arrow W to relatively move the printhead 1210 and the rubber elastic members serving as the wipers 221 and 222, thereby wiping the orifice surface 413 and the face surface 414. At this time, the rubber elastic members move, downstream in the wiping direction, ink attached to the orifice surface 413, and perform a cleaning operation without absorbing the ink. When a large amount of ink is attached to the orifice surface 413, the attached ink may enter the printhead 1210 from the orifices 402, generating color mixing. To solve such color mixing, the purge operation is performed on the recovery cap 211 after wiping (wiping operation) by the wipers 221 and 222, thereby ejecting the color-mixed ink entering the printhead 1210 from the orifice 402.

FIG. 18 is a schematic view showing the arrangement of the printhead 1210 and a buffer tank 401. Note that FIG. 18 is a schematic view of a channel for one color, but buffer tanks and channels for four, cyan, magenta, yellow, and black colors are constituted in one printhead 1210, as described above.

The supply tube 1205 is connected to a joint 404 of the printhead 1210 through the inside of the carriage 1202, and makes the ink tank 202 and the buffer tank 401 communicate with each other. Ink supplied to the printhead 1210 passes through a filter 405, passes through a channel inside the buffer tank 401, and reaches a first pressure regulating chamber 406. The first pressure regulating chamber 406 is connected to a second pressure regulating chamber 407. The first pressure regulating chamber 406 is also connected to the second pressure regulating chamber 407 via a pump 408 through another channel.

A valve 411 that opens when the pressure reaches a predetermined negative pressure is provided at the inlet port of the first pressure regulating chamber 406. A valve 412 that opens when the pressure reaches a predetermined negative pressure is provided at the inlet port of the second pressure regulating chamber 407. The inlet port of the first pressure regulating chamber 406 is provided between the first pressure regulating chamber 406 and the filter 405. The inlet port of the second pressure regulating chamber 407 is provided between the second pressure regulating chamber 407 and the first pressure regulating chamber 406. The negative pressure at which the valve 412 of the inlet port of the second pressure regulating chamber 407 opens is set to be higher than the negative pressure at which the valve 411 of the first pressure regulating chamber 406 opens.

In the chip 403, ink is supplied from the first pressure regulating chamber 406 via the joint 404 and a common supply channel 409 constituted in the printhead 1210 to the supply channel (to be described later) of one or a plurality of orifice arrays arranged within the chip 403. The ink having passed through the orifices 402 is returned to the second pressure regulating chamber 407 from a recovery channel (to be described later) within the chip 403 through a common recovery channel 410 constituted in the printhead 1210.

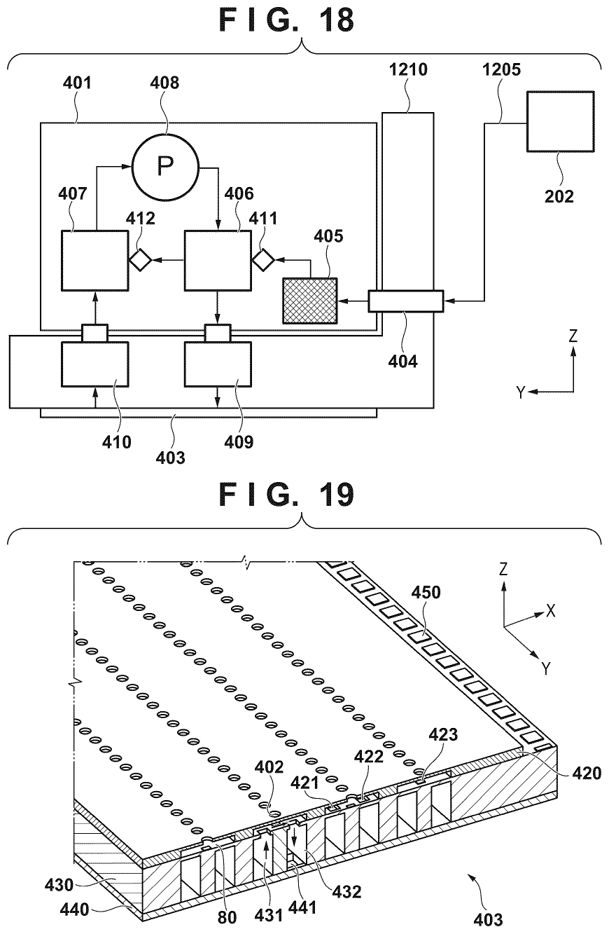

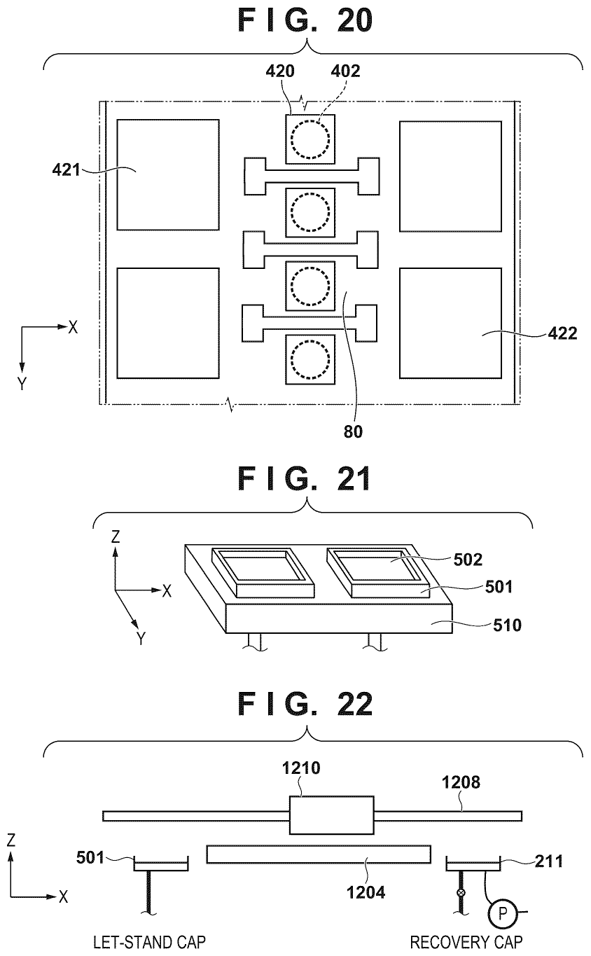

FIG. 19 is a sectional view showing the orifices 402, supply channels 431, and recovery channels 432 that are formed in the chip 403. FIG. 20 is a plan view showing the orifices 402, inlet ports 421, and outlet ports 422.

The chip 403 is formed by stacking an orifice plate 420, a substrate 430, and a cover plate 440. The orifice plate 420 in which a plurality of orifices 402 are formed is provided on the surface of the chip 403. Discharge energy generation elements 423 that generate discharge energy for discharging ink are provided on the substrate 430. In the chip 403, pressure chambers 80 are provided in correspondence with the discharge energy generation elements 423. As the discharge energy generation element 423, an electrothermal transducer (heater), a piezoelectric element, or the like can be used. When the heater is used, ink in the pressure chamber 80 is bubbled by generated heat, and discharged from the orifice 402 using the bubbling energy.

In a state in which ink is supplied into the orifice 402, the ink is kept at such a negative pressure as to form a meniscus in the orifice 402. Two channels for an inlet port 421 and an outlet port 422 are respectively formed on the two sides of the orifice 402. In the embodiment, one inlet port 421 and one outlet port 422 are arranged in correspondence with two orifices 402, as shown in FIG. 20. Note that the number of inlet ports 421 and that of outlet ports 422 may be one for one orifice 402, or two or more for one orifice 402.

The inlet port 421 is connected to the supply channel 431 formed along the orifice array 400, and the outlet port 422 is connected to the recovery channel 432 formed along the orifice array 400. The supply channel 431 and the recovery channel 432 are covered with the cover plate 440, and connected to the common supply channel 409 and common recovery channel 410 of the printhead 1210 via openings 441 on the cover plate 440. One or more openings 441 are provided for each supply channel 431 and each recovery channel 432. The number of openings 441 may be equal to or different from the numbers of supply channels 431 and recovery channels 432.

A method of supplying ink to the printhead 1210 and the buffer tank and a method of circulating ink in the orifice according to the embodiment will be explained below.

Ink is pressurized from the ink tank 202 (see FIG. 18), reaches the inside of the printhead 1210 via the supply tube 1205, passes through the filter 405, and then can be circulated within the printhead 1210. In a state in which the inside of the printhead 1210 is filled with ink at a proper negative pressure so as to hold a meniscus in the orifice 402, the valve 411 at the inlet port of the first pressure regulating chamber 406 is closed, and no ink flows into the first pressure regulating chamber 406. However, for example, when a high negative pressure is applied to the orifice 402 by the suction operation through the recovery cap 211 of the recovery unit 210, or when ink is discharged from the orifice 402, the negative pressure of the first pressure regulating chamber 406 increases, the valve 411 of the inlet port opens, and the ink flows into the first pressure regulating chamber 406.

As shown in FIG. 18, the first pressure regulating chamber 406 and the second pressure regulating chamber 407 are connected to the pump 408. When the pump 408 is driven, ink is transferred from the second pressure regulating chamber 407 to the first pressure regulating chamber 406 via the pump 408. In response to this, the negative pressure of the second pressure regulating chamber 407 increases, and when the valve 412 of the inlet port of the second pressure regulating chamber 407 opens, the ink flows back from the first pressure regulating chamber 406 to the second pressure regulating chamber 407. At this time, a pressure difference is generated between the first pressure regulating chamber 406 and the second pressure regulating chamber 407. Thus, the ink passes from the first pressure regulating chamber 406 through the channel in order of the common supply channel 409→the cover plate opening 441→the supply channel 431 of each orifice array→the inlet port 421, and part of the ink flows into the orifices 402 via the pressure chamber 80.

The ink in the pressure chamber 80 that is not discharged from the orifices 402 passes through the channel in order of the outlet port 422→the recovery channel 432→the cover plate opening 441→the common recovery channel 410, and returns to the second pressure regulating chamber 407 (see FIG. 19). That is, ink in the chip 403 flows in a direction indicated by arrows shown in FIG. 18.

Note that the negative pressure in the orifice 402 and the ink flow velocity are adjusted by the flow rate of the pump, the pressure loss of the channel between the first and second pressure chambers, and the on-off power of the valve of the inlet port so that a meniscus in the orifice 402 can be held.

FIG. 21 is a perspective view showing the let-stand unit 510. The let-stand unit 510 includes the let-stand caps 501 and absorbers 502. The let-stand unit 510 is supported by an elevating mechanism (not shown) so that it can be moved up/down, and is configured to be movable between an up position and a down position. At the up position, the let-stand cap 501 contacts the printhead 1210 and covers (can cap) the orifice surface 413 of the printhead 1210. At the time of the printing operation, the let-stand cap 501 is located at the down position in order to avoid interference with the printhead 1210 moving together with the carriage 1202. The absorber 502 capable of absorbing and holding a predetermined amount of ink is set in the let-stand cap 501, similar to the recovery cap 211.

Note that the internal dimensions of one let-stand cap 501 are 12 mm wide×45 mm long×3 mm deep, which is a size enough to cover the chip 403 by capping. The dimensions of the absorber 502 are 11 mm wide×mm long×1 mm high, and the absorber 502 does not contact the chip 403 even upon capping.

No pump is connected to the let-stand cap 501, unlike the recovery unit 210, and neither suction nor the purge operation is performed even upon capping the orifice surface 413 with the let-stand cap 501. Basically, neither ink nor dried ink exists in the let-stand cap 501. At the time of a non-printing operation, the orifice surface 413 is covered with the let-stand cap 501 to suppress evaporation of water from ink in the orifice 402 and thickening of the ink.

In this fashion, the let-stand cap 501 is used during standby in a state in which the orifice surface 413 of the printhead 1210 is capped at the time of the non-printing operation. The recovery cap 211 is used when the suction pump 213 is driven to perform suction for recovery processing or perform the purge operation.

FIG. 22 is a view showing the positional relationship between the recovery unit 210 and the let-stand unit 510 in the printing apparatus 1201 according to the embodiment. When the recovery unit 210 and the let-stand unit 510 are viewed from the front, the let-stand unit 510 is arranged on the left side with respect to the platen 1204, and the recovery unit 210 is arranged on the right side. Note that the positional relationship between the recovery unit 210 and the let-stand unit 510 is not particularly limited. For example, when the recovery unit 210 and the let-stand unit 510 are viewed from the front, the let-stand unit 510 may be arranged on the right side, and the recovery unit 210 may be arranged on the left side. Alternatively, the let-stand unit 510 and the recovery unit 210 may be arranged to be adjacent to each other on either the left or right side.

As described above, no ink attaches to the inside of the let-stand cap 501 in general. However, for example, when a shock is applied to the printhead 1210 during capping with the let-stand cap 501, or when air in the printhead 1210 expands due to a temperature change and the meniscus in the orifice 402 breaks, ink may drip into the let-stand cap 501. The ink dripping in the let-stand cap 501 dries during cap opening, resulting in dried ink. If the orifice surface 413 is capped in a state in which the dried ink exists in the let-stand cap 501, the dried ink in the let-stand cap 501 absorbs water, decreasing the humidity of the internal space of the let-stand cap 501. The ink in the orifice is deprived of water, and a discharge failure may occur.

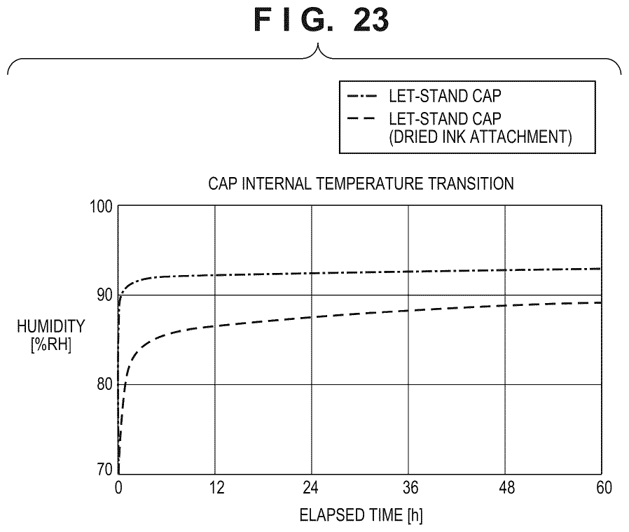

FIG. 23 is a graph showing the transition of a relative humidity in the let-stand cap 501 when the orifice surface 413 of the printhead 1210 is capped with the let-stand cap 501 after the printing operation in a 10% RH environment at 30° C. A dashed line represents a humidity transition when no dried ink exists in the let-stand cap 501, and a broken line represents a humidity transition when dried ink attaches to the inside of the let-stand cap 501. When no ink exists in the let-stand cap 501, water evaporates from ink in the orifice after capping and diffuses within the internal space of the let-stand cap. The humidity in the cap abruptly rises and counterbalances at a value corresponding to the vapor pressure of the ink in the orifice.

Note that when the humidity is increased from, for example, 10% RH at 30° C. to 100% RH at 30° C. in an effective volume (the absorber volume is subtracted from the internal volume of the cap) in the cap (in the capping unit) at the time of capping with the let-stand cap 501, the volume of water released to the internal space of the cap becomes about 0.03 mg. It was confirmed in the embodiment that at a water volume of about 0.03 mg, the influence of thickening of ink was less even upon evaporation of water from ink in the orifice, and the discharge performance was actually high 60 h after capping.

In contrast, when dried ink exists in the let-stand cap 501, it absorbs water that evaporates and diffuses from ink in the orifice to the internal space of the cap after capping, and the rise of the humidity transition in the cap becomes dull. In addition, water further evaporates and diffuses from the ink in the orifice, thickening of the ink in the orifice 402 progresses, and the equilibrium humidity in the cap decreases. It was confirmed in the embodiment that when dried ink existed in the cap, a discharge failure occurred 4 h after capping.

In this manner, when dried ink exists in the let-stand cap 501, thickening of the ink in the orifice progresses even during capping, and a discharge failure may occur. In the embodiment, generation of a discharge failure is suppressed by performing humidification control in the let-stand cap. Humidification control in the let-stand cap according to the embodiment will be explained below.

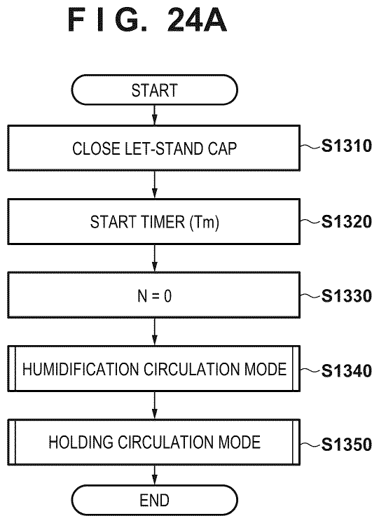

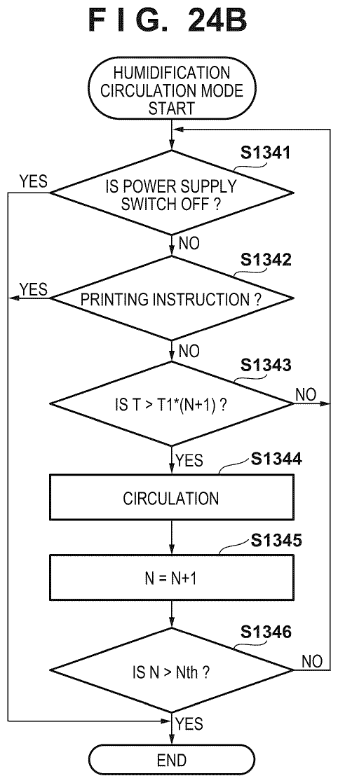

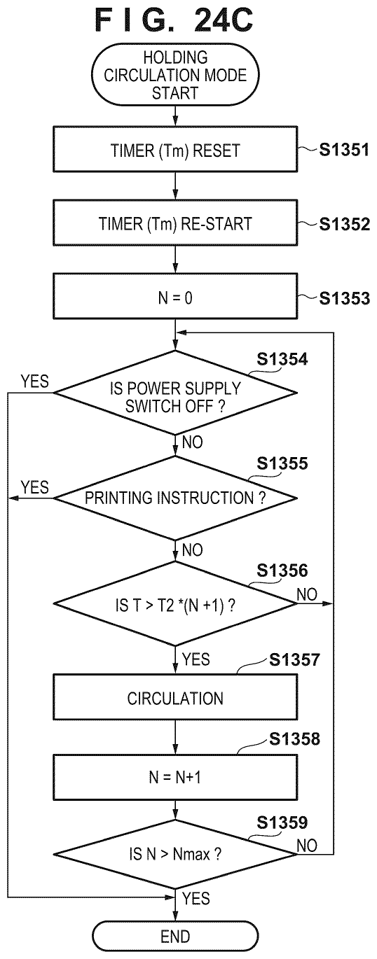

FIGS. 24A to 24C are flowcharts showing humidification control in the let-stand cap. FIG. 24A is a flowchart showing the overall humidification control in the let-stand cap. FIG. 24B shows processing in step S1340 of FIG. 24A, and FIG. 24C shows processing in step S1350 of FIG. 24A. A series of processes shown in FIGS. 24A to 24C is performed by deploying program codes stored in a memory 303 and executing them by a CPU 302 of the printing apparatus 1201. Alternatively, some or all of the functions of steps in FIGS. 24A to 24C may be implemented by hardware such as an ASIC or an electronic circuit. Note that sign “S” in the description of each process means a step in the flowchart. Humidification control in the let-stand cap according to the embodiment will be explained with reference to the flowchart of FIG. 24A.

Humidification control in the let-stand cap starts at a timing when printing is completed and the printhead 1210 comes to a position where it faces the let-stand cap 501. When humidification control in the let-stand cap starts, the CPU 302 controls the elevating mechanism of the let-stand cap 501 to change the let-stand cap 501 to a cap close state in step S1310. The CPU 302 starts a timer Tm in step S1320, and sets the number N of times of circulation=0 in step S1330. The timer Tm is the timer of the printing apparatus 1201, and counts an elapsed time (to be referred to as a capping time) T of the cap close state in the let-stand cap 501.

The CPU 302 can obtain a capping time at an arbitrary timing. Then, in step S1340, the CPU 302 controls the pump 408 in the printhead 1210 to execute a “humidification circulation mode” in which circulation is intermittently performed at every first circulation interval T1 (1 h in the embodiment) until the number N of times of circulation reaches an upper limit number (upper limit value) Nth of times=12. Upon completion of the humidification circulation mode, the CPU 302 executes in step S1350 a “holding circulation mode” in which intermittent circulation is performed at every second circulation interval T2 (24 h in the embodiment). Note that in the embodiment, one circulation time is 10 sec in either mode. The first circulation interval T1 is 1 h or shorter.

The humidification circulation mode is executed to hold high humidity even when dried ink attaches to the inside of the let-stand cap 501, while quickly humidifying the inside of the let-stand cap after capping. The holding circulation mode is also executed to periodically refresh thickening of ink in the orifice in the state of capping with the let-stand cap 501 wetted by the humidification circulation mode.

The humidification circulation mode will be explained with reference to the flowchart of FIG. 24B. When processing in the humidification circulation mode starts, the CPU 302 determines in step S1341 whether the power supply of the printing apparatus 1201 has been turned off. If the determination result is YES, the CPU 302 ends the humidification circulation mode. If the determination result is NO, the CPU 302 advances to step S1342. In step S1342, the CPU 302 determines whether there is a printing instruction. If the determination result is YES, the CPU 302 ends the humidification circulation mode. If the determination result is NO, the CPU 302 advances to step S1343.

In step S1343, the CPU 302 determines whether the elapsed time T according to the timer Tm has exceeded the first circulation interval T1×(number N of times of circulation+1). In the embodiment, the first circulation interval T1=1 h. If the determination result is NO, the CPU 302 returns to step S1341. If the determination result is YES, the CPU 302 advances to step S1344. In step S1344, the CPU 302 drives the pump 408 (see FIG. 18) in the printhead 1210 to circulate ink in the orifice. In the embodiment, the pump driving time (circulation time) for circulation is 10 sec. By this circulation, the orifice side from the supply channel 431 and the recovery channel 432 including the inside of the orifice is filled with fresh ink. As a result, the discharge stability (characteristic capable of stably discharging ink from the orifice) is recovered, the ability of humidification by ink near the orifice is also recovered, and the internal space of the let-stand cap 501 can be kept at high humidity.

In step S1345, the CPU 302 increments the number N of times of circulation by one. In step S1346, the CPU 302 determines whether the number N of times of circulation has exceeded the upper limit number Nth of times in the humidification circulation mode. In the embodiment, the upper limit number Nth of times=12, so the humidification circulation mode substantially continues for 12 h after capping. If the determination result is NO, the CPU 302 returns to step S1341 to continue the humidification circulation mode. If the determination result is YES, the CPU 302 ends the humidification circulation mode and shifts to the holding circulation mode in step S1350.

The holding circulation mode will be explained with reference to the flowchart of FIG. 24C. When processing in the holding circulation mode starts, the CPU 302 resets in step S1351 the elapsed time T of the timer Tm (T=0) in step S1351. In step S1352, the CPU 302 restarts the timer Tm. In step S1353, the CPU 302 resets the number N of times of circulation (N=0). In step S1354, the CPU 302 determines whether the power supply of the printing apparatus 1201 has been turned off. If the determination result is YES, the CPU 302 ends the holding circulation mode. If the determination result is NO, the CPU 302 advances to step S1355. In step S1355, the CPU 302 determines whether there is a printing instruction. If the determination result is YES, the CPU 302 ends the holding circulation mode. If the determination result is NO, the CPU 302 advances to step S1356.

In step S1356, the CPU 302 determines whether the elasped time T according to the timer Tm has exceeded the second circulation interval T2×(number N of times of circulation+1). In the embodiment, the second circulation interval T2=24 h. The internal space of the let-stand cap 501 and ink attached to the inside of the let-stand cap 501 are wetted through the humidification circulation mode in step S1340. Therefore, the second circulation interval T2 can be set to be longer than the first circulation interval T1. If the determination result is NO in step S1356, the CPU 302 returns to step S1354. If the determination result is YES, the CPU 302 advances to step S1357.

In step S1357, the CPU 302 drives the pump 408 (see FIG. 18) in the printhead 1210 to circulate ink in the printhead 1210. The pump driving time (circulation time) in the embodiment is 10 sec, similar to the humidification circulation mode. During the holding circulation mode, the progress of thickening of ink in the orifice is suppressed by wetting in the let-stand cap 501. Thus, the circulation time may be set to be shorter than that in the humidification circulation mode to a degree at which, for example, ink in the orifice is replaced with fresh ink.

In step S1358, the CPU 302 increments the number N of times of circulation by one. In step S1359, the CPU 302 determines whether the number N of times of circulation has exceeded an upper limit number Nmax of times in the holding circulation mode. In the embodiment, Nmax=60, so the holding circulation mode substantially continues for 60 days. Note that the upper limit number Nmax of times is set to prevent permanent continuation of the holding circulation mode. If the determination result is NO in step S1359, the CPU 302 returns to step S1353 to continue the holding circulation mode. If the determination result is YES, the CPU 302 ends the holding circulation mode. By these processes, all the steps of the humidification control in the let-stand cap shown in FIG. 24A end.

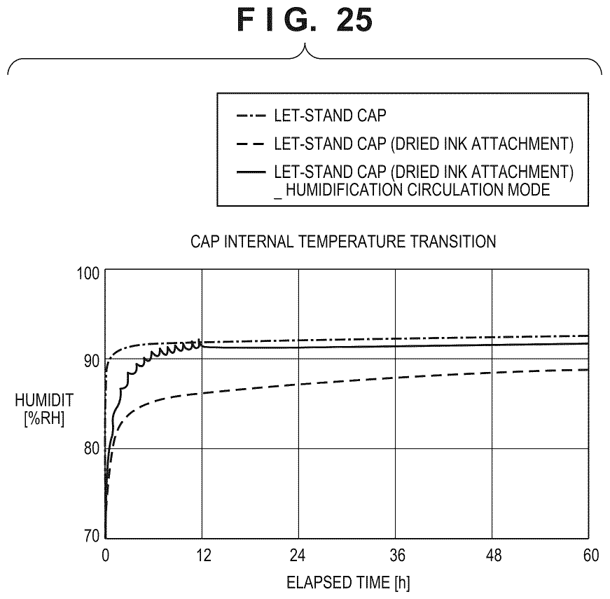

FIG. 25 is a graph showing the transition of a relative humidity in the let-stand cap 501 when the humidification circulation mode in the embodiment is executed in the 10% RH environment at 30° C. A solid line represents a humidity transition when the humidification circulation mode is executed in a state in which a predetermined amount (similar to the condition of the broken line in FIG. 23) of dried ink attaches to the inside of the let-stand cap 501. Note that a dashed line and a broken line in FIG. 25 represent data similar to those shown in FIG. 23 for comparison.

The humidification circulation mode is executed to perform intermittent circulation at a short time interval in a predetermined time after capping with the let-stand cap 501, thereby repetitively humidifying the inside of the let-stand cap. Even when dried ink attaches to the inside of the cap, the internal space of the cap can be kept in a relatively high humidity state. While the humidification circulation mode is executed (first circulation interval T1×upper limit number Nth of times), the dried ink attached to the inside of the cap is in the high-humidity environment, gradually absorbs water, and becomes wet. Even after the humidification circulation mode ends, the inside of the let-stand cap can be kept at high humidity.

Note that the humidity in the let-stand cap 501 rises to only a value corresponding to the water vapor pressure of ink in the orifice, so the attached dried ink can be prevented from becoming (excessively) wetter than the original state. When ink attached to the inside of the let-stand cap 501 dries slightly or when the amount of attached ink is small, the attached ink can be wetted in accordance with the state, and the let-stand cap 501 can be kept at an appropriate humidity without excessively drying the let-stand cap 501. If no dried ink exist in the cap, the internal space of the cap can be efficiently humidified without deprivation of water by dried ink.

As described above, circulation is performed at a relatively short interval (1 h) till the lapse of a predetermined time (24 h) after capping with the let-stand cap, and after the predetermined period, circulation is performed at a relatively long interval. The inside of the cap can be properly wetted regardless of whether ink drips into the cap. As a result, generation of a discharge failure and thickening of ink in the orifice can be suppressed without impairing the usability of the user.

### Fifth Embodiment

The fifth embodiment of the present disclosure will be explained below with reference to the accompanying drawings. Note that the basic arrangement of the fifth embodiment is similar to that of the fourth embodiment, so a characteristic arrangement will be described below. In the fifth embodiment, after capping with a let-stand cap 501, the humidification circulation mode is performed without performing the holding circulation mode, and upon receiving a printing start signal, recovery circulation is performed. The recovery circulation is a circulating operation that is performed on a printhead before the start of the printing operation. In the embodiment, the time of the circulating operation in recovery circulation is changed in accordance with the execution state of the humidification circulation mode.

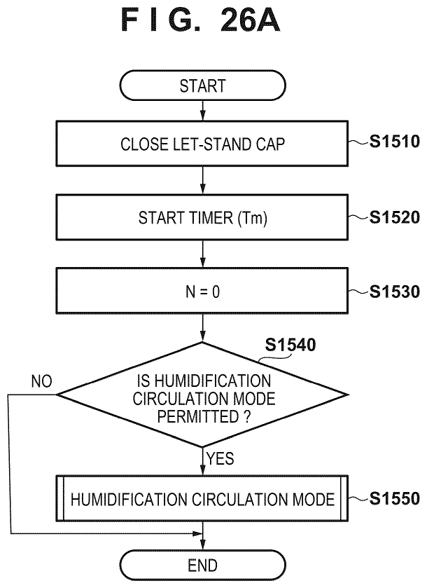

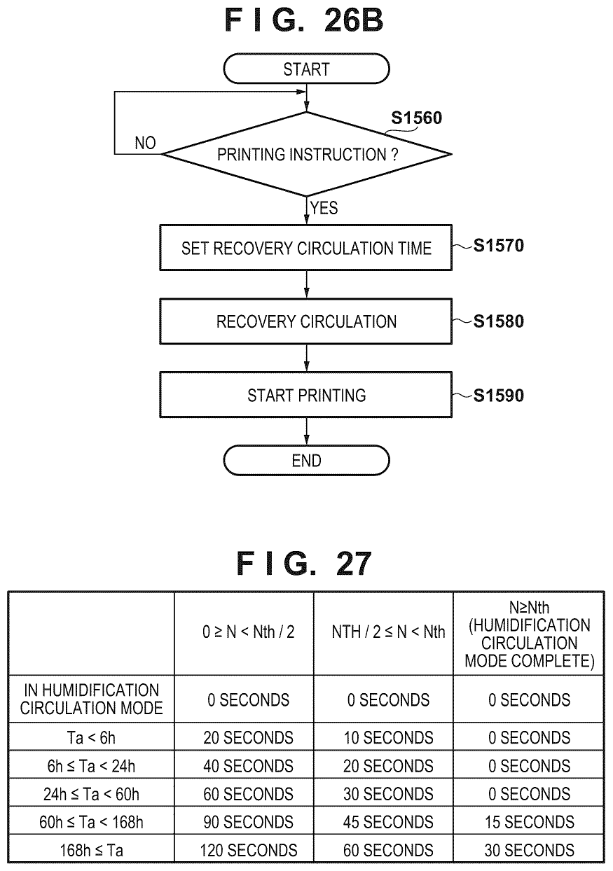

FIG. 26A is a flowchart showing humidification control in the let-stand cap according to the embodiment. FIG. 26B is a flowchart showing recovery circulation processing. A series of processes shown in FIGS. 26A and 26B is performed by deploying program codes stored in a memory 303 and executing them by a CPU 302 of a printing apparatus 1201. Alternatively, some or all of the functions of steps in FIGS. 26A and 26B may be implemented by hardware such as an ASIC or an electronic circuit. Note that sign “S” in the description of each process means a step in the flowchart. Humidification control in the let-stand cap according to the embodiment will be explained with reference to the flowchart of FIG. 26A.

Humidification control in the let-stand cap starts at a timing when printing is completed and the printhead 1210 comes to a position where it faces the let-stand cap 501. When humidification control in the let-stand cap starts, the CPU 302 controls the elevating mechanism of the let-stand cap 501 to change the let-stand cap 501 to a cap close state in step S1510. The CPU 302 starts a timer Tm in step S1520, and sets the number N of times of circulation=0 in step S1530.

In step S1540, the CPU 302 determines whether the humidification circulation mode is permitted. If the humidification circulation mode is permitted, the CPU 302 shifts to the humidification circulation mode in step S1550. In the embodiment, the user can arbitrarily select whether the humidification circulation mode can be executed. It is effective not to execute (not to permit) the humidification circulation mode immediately after the start of using the apparatus or in a situation in which no discharge failure has occurred, and to execute (to permit) the humidification circulation mode in a situation in which a discharge failure is more reliably suppressed, or in a situation in which a discharge failure has already occurred. In the embodiment, the user can selectively set whether the humidification circulation mode can be executed. Note that the humidification circulation mode (step S1550) is similar to that in the first embodiment, and a description thereof will not be repeated.

Recovery circulation processing according to the embodiment will be explained with reference to the flowchart of FIG. 26B. Humidification control in the let-stand cap in FIG. 26A and recovery circulation processing in FIG. 26B are performed in parallel.

Upon receiving a printing start signal, the CPU 302 obtains an elapsed time Ta in the timer Tm and the number N of times of circulation, and sets a circulation time for recovery by looking up a recovery circulation time selection table (to be described later) in step S1570. In step S1580, the CPU 302 executes recovery circulation based on the recovery circulation time set in step S1570. Then, the CPU 302 starts the printing operation in step S1590, and ends the processing.

FIG. 27 is a table showing the recovery circulation time selection table that is looked up in the recovery circulation time setting processing according to the embodiment. The recovery circulation time selection table is looked up in step S1570 of FIG. 26B. For example,, when the power supply is turned off upon the number N of times of circulation=4 in the humidification circulation mode, and a printing signal is input at the timing of Ta=48 h, the CPU 302 sets 60 sec as the recovery circulation time based on the upper limit number Nth of times=12. Note that the timer Tm keeps measuring the elapsed time even in the power-off state. When the number N of times of circulation in the humidification circulation mode has reached the upper limit number Nth of times=12, and a printing signal is input at the timing of Ta=48 h, the CPU 302 sets 0 sec (none) as the recovery circulation time.

In this way, when the humidification circulation mode is interrupted halfway, the wet state in the let-stand cap 501 may be insufficient, so a long recovery circulation time is set. When the humidification circulation mode is executed to the end, a short recovery circulation time is set. Note that intermittent circulation is performed in a short time (first circulation interval T1) during the humidification circulation mode. Hence, when a printing signal is input during the humidification circulation mode, 0 sec (none) is set as the recovery circulation time.

As described above, according to the embodiment, the humidification circulation mode is performed immediately after capping with the let-stand cap 501. When a printing signal is input, the recovery operation before the start of printing is performed in a circulation time corresponding to the execution state of the humidification circulation mode.

### Sixth Embodiment

The sixth embodiment of the present disclosure will be described below with reference to the accompanying drawings. Note that the basic arrangement of the sixth embodiment is similar to that of the fourth embodiment, so a characteristic arrangement will be described below. In the sixth embodiment, control of detecting an ink attachment amount in a let-stand cap 501, and setting the upper limit number Nth of times of the humidification circulation mode in accordance with the detected ink attachment amount will be explained. In the embodiment, a printing apparatus 1201 includes a detection unit (not shown) for detecting an ink attachment amount in the let-stand cap 501. The detection unit captures an image of an absorber 502 (see FIG. 21) in the let-stand cap by using an image sensor (not shown), and derives an ink attachment ratio from the ink attachment area in the absorber 502.

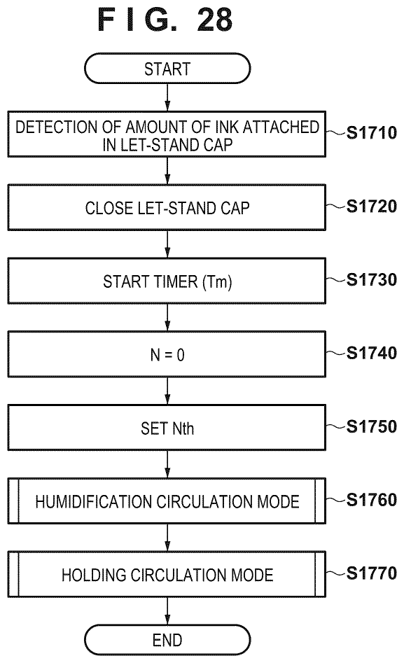

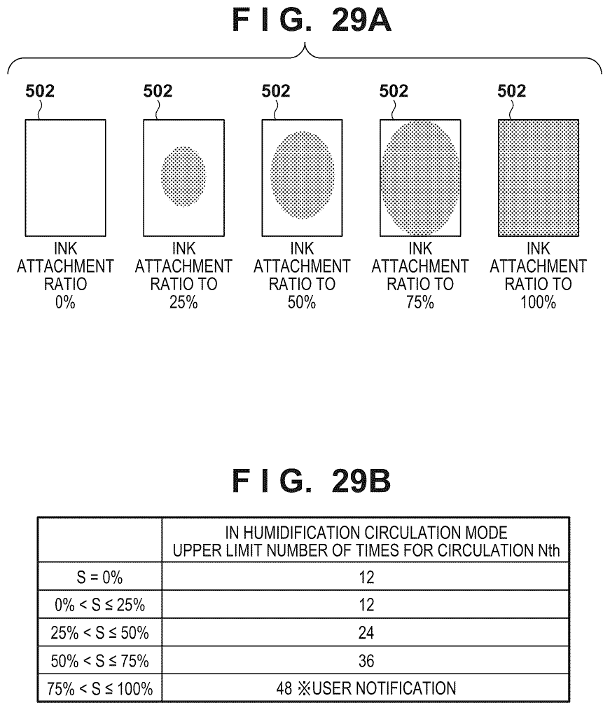

FIG. 28 is a flowchart showing humidification control in the let-stand cap according to the embodiment. FIG. 29A is a view showing an example of detection of an ink attachment ratio S to the absorber 502, and FIG. 29B is a table showing a table for setting the upper limit number Nth of times. A series of processes shown in FIG. 28 is performed by deploying program codes stored in a memory 303 and executing them by a CPU 302 of the printing apparatus 1201. Alternatively, some or all of the functions of steps in FIG. 28 may be implemented by hardware such as an ASIC or an electronic circuit. Note that sign “S” in the description of each process means a step in the flowchart. Humidification control in the let-stand cap according to the embodiment will be explained with reference to the flowchart of FIG. 28.

When humidification control in the let-stand cap 501 starts, the CPU 302 captures an image of the absorber 502 in the let-stand cap 501 by using the image sensor (not shown), and derives the ink attachment ratio S from the ink attachment area in the absorber 502 in step S1710. As shown in FIG. 29A, the ink attachment ratio S is derived from the ratio of a portion at which ink attaches to the absorber 502. Note that the ink attachment amount is detected before cap closing in the embodiment, but it may be detected at another timing to obtain the latest detection result. The ink attachment amount detection unit is not limited to the image sensor. For example, an electrode may be arranged in the cap to detect an attachment amount or the presence/absence of attachment. Alternatively, a humidity sensor may be arranged in the cap to estimate an ink attachment amount from humidity transition at the time of capping.

In step S1720, the CPU 302 controls the elevating mechanism of the let-stand cap 501 to change the let-stand cap 501 to a cap close state. In step S1730, the CPU 302 starts a timer Tm. In step S1740, the CPU 302 resets the number N of times of circulation (N=0).

In step S1750, the CPU 302 sets the upper limit number Nth of times in the humidification circulation mode by looking up the table in FIG. 29B based on the ink attachment ratio S obtained in step S1710. For example, when the ink attachment ratio S is 10%, the upper limit number Nth of times=12 is set. When the ink attachment ratio S is 60%, the upper limit number Nth of times=36 is set. This is because, as the dried ink amount in the cap is larger, it takes a longer time to wet the inside of the cap. Thus, the execution time of the humidification circulation mode is prolonged so that the inside of the cap can be kept at high humidity for a longer time. Note that when the ink attachment ratio S exceeds 75%, the upper limit number Nth of times=48 is selected, and the user is notified to, for example, clean the let-stand cap 501.

Here, the upper limit number Nth of times is set based on the ink attachment ratio S, but the first circulation interval T1 is not set particularly based on the ink attachment ratio S. This is because the first circulation interval T1 is a variable that has a short-term influence, and rarely affects drying based on the ink attachment ratio S. To the contrary, the upper limit number Nth of times is a variable that has a long-term influence, and readily affects drying based on the ink attachment ratio S. Therefore, the upper limit number Nth of times is selected in consideration of the ink attachment ratio S.

In step S1760, the CPU 302 shifts to the humidification circulation mode. The CPU 302 executes the holding circulation mode based on the upper limit number Nth of times set in step S1750. In step S1770, the CPU 302 shifts to the holding circulation mode. The humidification circulation mode and the holding circulation mode are similar to those described in the fourth embodiment, and a description thereof will not be repeated. By the above processing, the humidification control processing in the let-stand cap according to the embodiment ends.

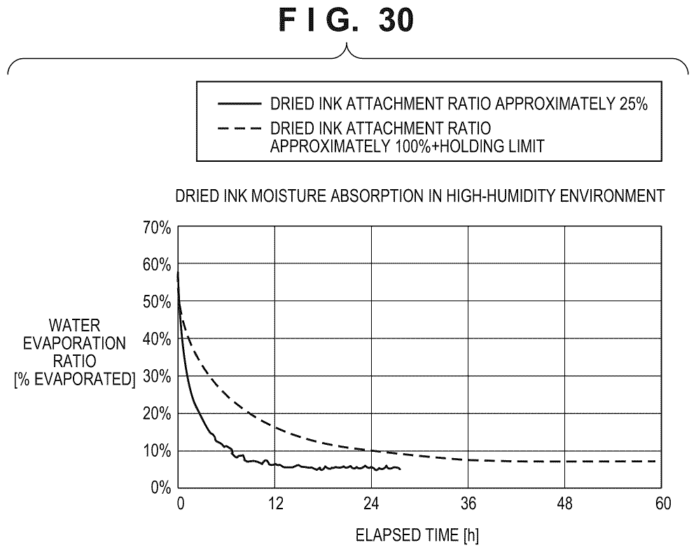

FIG. 30 is a graph showing the transition of the water evaporation ratio of attached dried ink when the dried ink-attached let-stand cap 501 was set in a 90% RH high-humidity environment at 30° C. A solid line represents the transition of the water evaporation ratio of attached ink when a state in which the ink attachment ratio S was about 25% and ink was dried was defined as an initial state. In this condition, dried ink that initially evaporated by 60% was wetted, evaporated by about 6% after 12 h, and hardly changed thereafter.

A broken line represents the transition of the evaporation ratio of attached ink when a state in which the ink attachment ratio S was 100% and ink was dropped till the limit of holding of the absorber 502 and then dried was defined as an initial state. The wetting speed was lower in comparison with a small dried ink amount, and in this condition, the ink evaporated by about 6% after about 48 h.

As described above, the time taken for wetting differs depending on the amount of dried ink attached to the inside of the let-stand cap 501. However, according to the embodiment, a proper high-humidity holding time corresponding to the ink attachment amount can be ensured.

### Seventh Embodiment

The seventh embodiment of the present disclosure will be described below with reference to the accompanying drawings. Note that the basic arrangement of the seventh embodiment is similar to that of the fourth embodiment, so a characteristic arrangement will be described below. In the seventh embodiment, a printing apparatus 1201 includes an ink attachment amount detection unit in a let-stand cap 501. In the embodiment, a water evaporation amount Vco is calculated from ink attached to the inside of the cap in accordance with the open time of the let-stand cap 501, and Vco is added to water that is lost from ink in a circulation path when the humidification circulation mode is performed.

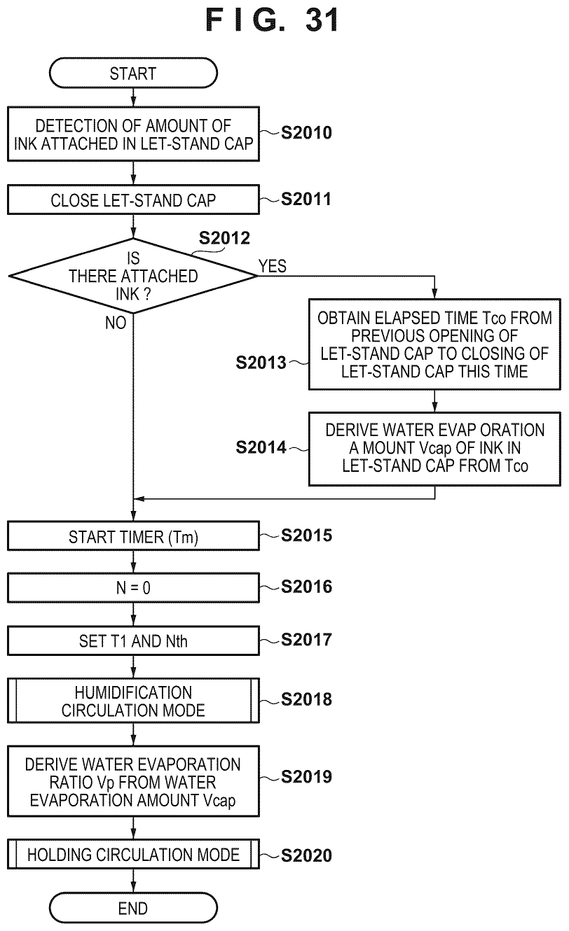

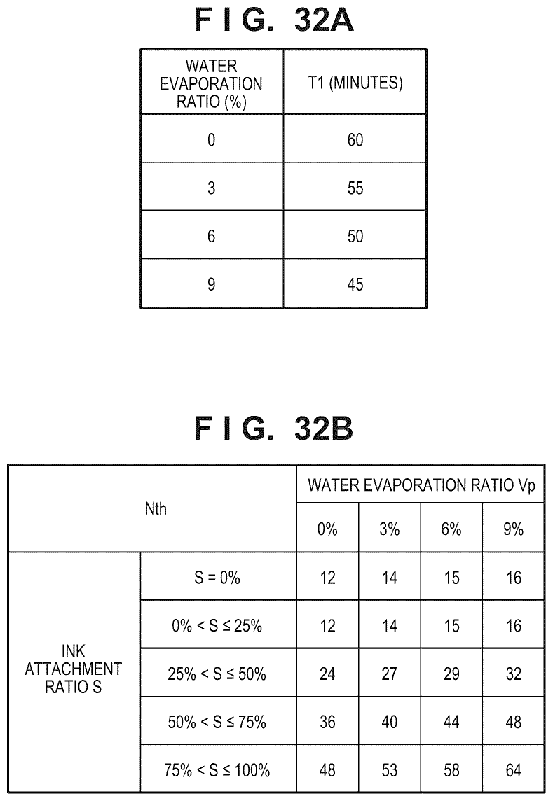

FIG. 31 is a flowchart showing humidification control in the let-stand cap according to the embodiment. FIGS. 32A and 32B are tables that are looked up in the flowchart of FIG. 31. A series of processes shown in FIG. 31 is performed by deploying program codes stored in a memory 303 and executing them by a CPU 302 of the printing apparatus 1201. Alternatively, some or all of the functions of steps in FIG. 31 may be implemented by hardware such as an ASIC or an electronic circuit. Note that sign “S” in the description of each process means a step in the flowchart. Humidification control in the let-stand cap according to the embodiment will be explained with reference to the flowchart of FIG. 31. Processes in steps S2010 and S2011 are similar to those in steps S1710 and S1720 in FIG. 28 according to the sixth embodiment. Processes in steps S2015, S2016, and S2018 are similar to those in steps S1730, S1740, and S1760 in FIG. 28. Therefore, a description of the processes in steps S2010, S2011, S2015, S2016, and S2018 will not be repeated.

In step S2012, the CPU 302 determines whether there is ink attached inside the let-stand cap 501. If no ink attaches and the determination result is NO, the CPU 302 advances to step S2015. If ink attaches inside the let-stand cap 501 and the determination result is YES, the CPU 302 advances to step S2013. In step S2013, the CPU 302 obtains the elapsed time Tco from previous opening to closing (step S2011) of the let-stand cap 501. In step S2014, the CPU 302 derives a water evaporation amount Vcap of the ink attached inside the let-stand cap 501 based on the ink attachment amount in the let-stand cap 501 obtained in step S2010, and the elapsed time Tco obtained in step S2013.

In step S2017, the CPU 302 sets the first circulation interval Tl and the upper limit number Nth of times in the humidification circulation mode. The first circulation interval T1 is set based on a water evaporation ratio Vp (obtaining result) obtained in step S2019 (to be described later) and the table of FIG. 32A. In a state in which no water evaporates after the start of using the apparatus, 60 min for the water evaporation ratio Vp=0% in the table of FIG. 32A is selected.

The upper limit number Nth of times is selected based on the water evaporation ratio Vp obtained in step S2019 (to be described later), and the ink attachment ratio S obtained in step S2010. In a state in which no water evaporates after the start of using the apparatus, the water evaporation ratio Vp=0% in the table of FIG. 32B, and the upper limit number Nth of times is set based on the ink attachment ratio S obtained in step S2010.

In a state in which no water evaporates after the start of using the apparatus, the ink-attached let-stand cap 501 is open for a predetermined time, and even if the water of the ink attached to the let-stand cap 501 evaporates, the water amount of ink in the path at this time does not change. Then, the let-stand cap 501 is closed to perform the humidification circulation mode (holding circulation mode), and the dried ink attached to the let-stand cap 501 deprives the ink in the path of water via the orifice. Through the humidification circulation mode (holding circulation mode), the water amount of ink in the path decreases, and the ink near the orifice thickens. After the second time, the first circulation interval T1 and the upper limit number Nth of times are decided based on water evaporated during the time during which the let-stand cap 501 was open.

In step S2019, the CPU 302 derives the water evaporation ratio Vp from the water evaporation amount Vcap of the ink attached inside the let-stand cap that has been obtained in step S2013. Thereafter, the CPU 302 performs the holding circulation mode in step S2020, and ends the processing.

In this fashion, it is also possible to obtain a water evaporation amount in accordance with the time in which the let-stand cap 501 is open, and decide the first circulation interval T1 and the upper limit number Nth of times.

### Eighth Embodiment

The eighth embodiment of the present disclosure will be explained below with reference to the accompanying drawings. Note that the basic arrangement of the eighth embodiment is similar to that of the fourth embodiment, so a characteristic arrangement will be described below.

In each of the above-described embodiments, both the let-stand cap 501 and the recovery cap 211 are provided. In the eighth embodiment, no let-stand cap is provided in terms of the main body size and the cost, and one cap is used for both recovery and let-stand. In this case, a large amount of ink always exists in the cap. When one cap is used for both recovery and let-stand, the amount of ink attached inside the cap becomes larger, compared to the case where the let-stand cap is provided. It is therefore desirable that the first circulation interval T1 of the humidification circulation mode is shorter and the upper limit number Nth of times is larger than those in the first to fourth embodiments.

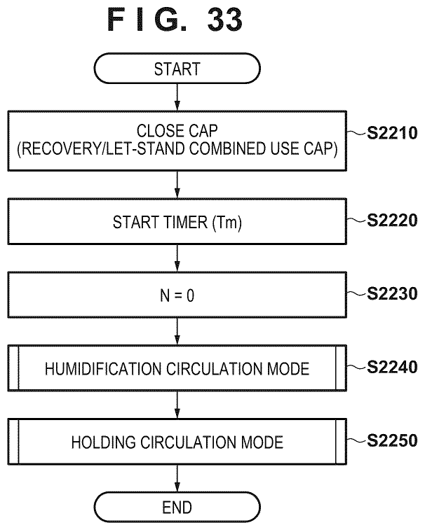

FIG. 33 is a flowchart showing humidification control in the cap according to the embodiment. A series of processes shown in FIG. 33 is performed by deploying program codes stored in a memory 303 and executing them by a CPU 302 of a printing apparatus 1201. Alternatively, some or all of the functions of steps in FIG. 33 may be implemented by hardware such as an ASIC or an electronic circuit. Note that sign “S” in the description of each process means a step in the flowchart. Humidification control in the let-stand cap according to the embodiment will be explained with reference to the flowchart of FIG. 33.

When humidification control in the let-stand cap starts, the CPU 302 controls the elevating mechanism of the recovery/let-stand cap to change the recovery/let-stand cap (not shown) to a cap close state in step S2210. The CPU 302 starts a timer Tm in step S2220, and sets the number N of times of circulation=0 in step S2230. The timer Tm is the timer of the printing apparatus 1201, and counts the elapsed time (to be referred to as a capping time) of the cap close state in the recovery/let-stand cap.

A printing control unit 301 can obtain the capping time at an arbitrary timing. In step S2230, the CPU 302 sets the number N of times of circulation=0. In step S2240, the CPU 302 controls a pump 408 in a printhead 1210 to shift to a “humidification circulation mode” in which intermittent circulation is performed at every first circulation interval T1 (30 min in the embodiment) until the number N of times of circulation reaches the upper limit number Nth of times=96. Upon completion of the humidification circulation mode, the CPU 302 shifts in step S2250 to a “holding circulation mode” in which intermittent circulation is performed at every second circulation interval T2 (24 h in the embodiment). Note that in the embodiment, one circulation time is 10 sec in either mode.

It suffices to set the upper limit number of times of circulation as long as ink attached inside the cap can be satisfactorily humidified. By setting the upper limit number of times for circulation in the above-described way, excessive circulation is suppressed without impairing the usability of the user.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. A liquid discharge apparatus comprising:
a cap unit configured to cover and cap an orifice surface on which an orifice of a discharge unit configured to discharge a liquid is provided; and
a circulation unit configured to communicate with the orifice of the discharge unit, and circulate a liquid through a circulation path,
wherein the cap unit includes a first cap configured not to receive the liquid, and
wherein the circulation unit performs an operation of circulating the liquid through the circulation path in a state in which the cap unit covers the orifice surface.

2. The apparatus according to claim 1, wherein the circulation unit performs the operation in a state in which the first cap covers the orifice surface.

3. The apparatus according to claim 2, wherein the cap unit includes a second cap configured to cover the orifice surface and receive the liquid.

4. The apparatus according to claim 3, further comprising a suction unit configured to suck the liquid from the orifice surface via the second cap.

5. The apparatus according to claim 4, wherein the suction unit includes:
a suction tube connected to the second cap; and
a pressure reducing pump configured to reduce, via the suction tube, a pressure of a second cap space formed by covering the orifice surface with the second cap.

6. The apparatus according to claim 2, wherein the operation of the circulation unit is stopped based on a condition about a humidity change of a first cap space formed by covering the orifice surface with the first cap.

7. The apparatus according to claim 1, wherein the operation of the circulation unit is stopped on condition that a first time has elapsed after a start of circulating the liquid through the circulation path.

8. The apparatus according to claim 7, wherein the operation of the circulation unit is restarted in a case where a second time has elapsed after the operation of the circulation unit is stopped in response to the lapse of the first time.

9. The apparatus according to claim 2, further comprising a measurement unit configured to measure a humidity of a first cap space formed by covering the orifice surface with the first cap,
wherein the operation of the circulation unit is stopped on condition that the humidity of the first cap space measured by the measurement unit has reached a first value.

10. The apparatus according to claim 9, wherein the operation of the circulation unit is restarted in a case where the humidity of the first cap space measured by the measurement unit has reached a second value smaller than the first value after the operation of the circulation unit is stopped in a case where the humidity of the first cap space reaches the first value.

11. The apparatus according to claim 1, wherein the first cap includes a communication path configured to make a first cap space formed by covering the orifice surface with the first cap and an external space communicate with each other.

12. The apparatus according to claim 11, wherein the communication path has a labyrinth shape.

13. The apparatus according to claim 1, wherein the first cap does not include an absorber configured to absorb a liquid.

14. The apparatus according to claim 1, wherein the first cap covers the orifice surface in a case where the discharge unit is let stand.

15. The apparatus according to claim 1, wherein the first cap is a cap not accompanied by suction of the liquid from the orifice surface in a case where the first cap covers the orifice surface.

16. The apparatus according to claim 1, wherein the liquid discharge apparatus is a printing apparatus configured to discharge ink as the liquid to a printing medium.

17. The apparatus according to claim 1, further comprising a control unit configured to control the cap unit and the circulation unit,
wherein the control unit executes a first circulation mode in which, after the orifice surface is capped with the cap unit, the circulation unit is controlled to intermittently circulate the liquid at a first time interval, and
ends the first circulation mode in a case where the number of times by which the intermittent circulation is performed in the first circulation mode reaches a first upper limit value.

18. The apparatus according to claim 17, wherein the control unit executes a second circulation mode in which, after the first circulation mode is executed, the circulation unit is controlled to intermittently circulate the liquid at a second time interval longer than the first time interval, and
ends the second circulation mode in a case where the number of times by which the intermittent circulation is performed in the second circulation mode reaches a second upper limit value.

19. The apparatus according to claim 18, wherein the first time interval is not longer than 1 h, the first upper limit value is 24 times, the second time interval is 24 h, and the second upper limit value is 60 times.

20. The apparatus according to claim 17, wherein in a case where a signal for discharge by the discharge unit is input in a state in which the orifice surface is capped, the control unit controls the circulation unit to perform circulation by a predetermined time corresponding to a time elapsed after capping, and the number of times of circulation in the first circulation mode.

21. The apparatus according to claim 20, wherein the control unit sets the predetermined time to be a longer time as the time elapsed after capping is longer, and to be a shorter time as the number of times of circulation in the first circulation mode is larger.

22. The apparatus according to claim 17, further comprising a detection unit configured to detect an ink attachment amount in the cap unit,
wherein the control unit sets the first upper limit value based on a detection result of the detection unit.

23. The apparatus according to claim 22, wherein the control unit sets the first upper limit value to be a larger value as the ink attachment amount detected by the detection unit is larger.

24. The apparatus according to claim 22, further comprising an obtaining unit configured to obtain a water evaporation ratio of ink in the cap unit,
wherein the control unit sets the first time interval and the first upper limit value based on an obtaining result of the obtaining unit.

25. The apparatus according to claim 24, wherein the control unit sets the first time interval to be a smaller value and the first upper limit value to be a larger value as the water evaporation ratio of ink in the cap unit is larger.

26. The apparatus according to claim 17, wherein the cap unit includes a second cap connected to a suction unit configured to suck the liquid from the orifice, and the first cap configured to tightly close the orifice, and
in a case where the first circulation mode is performed, the control unit performs capping with the first cap.

27. The apparatus according to claim 1, wherein the circulation path including a containing portion configured to contain the liquid discharged from the orifice.

28. A control method of a liquid discharge apparatus including:
a cap unit configured to cover and cap an orifice surface on which an orifice of a discharge unit configured to discharge a liquid is provided; and
a circulation unit configured to communicate with the orifice of the discharge unit, and circulate a liquid through a circulation path,
wherein the cap unit includes a first cap configured not to receive the liquid,
the method comprising controlling the circulation unit to execute an operation of circulating the liquid through the circulation path in a state in which the cap unit covers the orifice surface.
